(19) United States
(12) Patent Application Publication
(10) Pub. No.: US 2019/0375667 A1
(43) Pub. Date: Dec. 12, 2019

(54) METHODS AND APPARATUSES FOR COMPENSATING FOR FORMING BODY DIMENSIONAL VARIATIONS

(71) Applicant: CORNING INCORPORATED, CORNING, NY (US)

(72) Inventors: Olus Naili Boratav, Ithaca, NY (US); Robert Delia, Horseheads, NY (US); Bulent Kocatulum, Horseheads, NY (US); Michael Yoshiya Nishimoto, Horseheads, NY (US); Gaozhu Peng, Horseheads, NY (US); Jae Hyun Yu, Big Flats, NY (US)

(21) Appl. No.: 16/462,998

(22) PCT Filed: Nov. 21, 2017
(86) PCT No.: PCT/US17/62706

§ 371 Date: May 22, 2019

Related U.S. Application Data
(60) Provisional application No. 62/425,681, filed on Nov. 23, 2016.
(60) Provisional application No. 62/524,806, filed on Jun. 26, 2017.

(51) Int. Cl. C03B 17/06

(52) U.S. Cl. CPC C03B 17/064

(57) ABSTRACT

A glass forming apparatus may include a forming body positioned within an enclosure having a top panel and a pair of side panels. The forming body includes an inlet end and a trough defined by a pair of spaced apart weirs extending with an incline from the inlet end. The top panel is positioned above and extends substantially parallel to and across top surfaces of the pair of spaced apart weirs. The apparatus may also include a support plate positioned above and extending substantially parallel to and across the top panel of the enclosure and the weirs. An array of thermal elements of uniform size are suspended from the support plate and positioned above the trough of the forming body. The array of thermal elements may have bottom portions that are positioned equidistant from the top panel of the enclosure along the length of the forming body.

### CROSS-REFERENCE TO RELATED APPLICATIONS

This application claims the benefit of priority under 35 U.S.C. § 119 of U.S. Provisional Application Ser. No. 62/425,681 filed on Nov. 23, 2016 and Provisional Application Ser. No. 62/524,806 filed on Jun. 26, 2017 the contents of which are relied upon and incorporated herein by reference in their entirety as if fully set forth below.

### BACKGROUND

### Field

The present specification generally relates to glass forming apparatuses and, more specifically, to methods and apparatuses for compensating for forming body dimensional variations during formation of continuous glass ribbons.

### Technical Background

The fusion process is one technique for forming continuous glass ribbons. Compared to other processes for forming glass ribbons, such as the float and slot-draw processes, the fusion process produces glass ribbons with a relatively low amount of defects and with surfaces having superior flatness. As a result, the fusion process is widely employed for the production of glass substrates that are used in the manufacture of LED and LCD displays and other substrates that require superior flatness and smoothness.

In the fusion process, molten glass is fed into a forming body (also referred to as an isopipe) with forming surfaces which converge at a root. The molten glass evenly flows over the forming surfaces of the forming body and forms a ribbon of flat glass with pristine surfaces drawn from the root of the forming body.

The forming body is generally made of refractory materials, such as refractory ceramics, which are better able to withstand the relatively high temperatures of the fusion process. However, the most temperature-stable refractory ceramics may creep over extended periods of time at elevated temperatures and result in dimensional changes to the forming body and potentially resulting in the degradation of characteristics of the glass ribbon produced therefrom or even failure of the forming body. Either case may result in disruption of the fusion process, lower product yields, and increased production costs.

Accordingly, a need exists for alternative methods and apparatuses for mitigating dimensional changes in forming bodies of glass forming apparatuses.

### SUMMARY

According to one embodiment, a glass forming apparatus for forming a glass ribbon from molten glass may include an enclosure with a top panel and a pair of side panels, and a forming body positioned within the enclosure. The forming body comprises a trough for receiving molten glass positioned below the top panel of the enclosure. The trough is defined by an inlet end, a distal end, a first weir and a second weir opposite and spaced apart from the first weir, and a base extending between the first weir and the second weir along a length of the forming body, The first weir and the second weir extend from the inlet end to the distal end at an incline with respect to horizontal, and the top panel of the enclosure is positioned above and extends substantially parallel to and across top surfaces of the first weir and the second weir along the length of the forming body. A support plate positioned above and extending substantially parallel to and across the top panel of the enclosure along the length of the forming body is included. A plurality of thermal elements are suspended from the support plate along the length of the forming body and wherein the plurality of thermal elements locally heat or cool molten glass within the trough. In embodiments, a plurality of thermal shields are suspended from the support plate along the length and width of the forming body. The plurality of thermal shields form a plurality of hollow columns and the plurality of thermal elements are positioned within the plurality of hollow columns. In some embodiments, the plurality of hollow columns are of uniform cross-sectional size and volume and the plurality of thermal elements are of uniform length.

In another embodiment, a method for forming a glass ribbon includes directing molten glass into a trough of a forming body with an inlet end, the trough defined by a first weir and a second weir opposite and spaced apart from the first weir, and a base extending between the first weir and the second weir along a length of the forming body. The forming body is enclosed within an enclosure with a top panel and the first and second weirs extend from the inlet end of the forming body at an incline. The top panel is positioned above and extends substantially parallel to and across top surfaces of the first weir and second weirs along the length of the forming body. Molten glass flows over the first weir and the second weir and down along a first forming surface and a second forming surface extending from the first weir and the second weir, respectively. The first forming surface and the second forming surface converge at a root and the molten glass flowing down along the first forming surface and the second forming surface converge at the root and form the glass ribbon. The molten glass is locally heated or cooled in the trough with a plurality of thermal elements positioned above the forming body and suspended from a support plate. The support plate is positioned above and extends substantially parallel to and across the top panel of the enclosure along the length of the forming body. The local heating or cooling of the molten glass in the trough manipulates temperature and viscosity of the molten glass along the length of the trough. In embodiments, the plurality of thermal elements is a plurality of heating elements of uniform length with bottom portions of the plurality of heating elements equidistant from the top panel of the enclosure along the length of the forming body. The plurality of thermal elements may be positioned within a plurality of hollow columns formed by a plurality of thermal shields suspended from the support plate along the length and a width of the forming body. The plurality of hollow columns may have a uniform cross-sectional size and volume along the length of the forming body.

Additional features and advantages of the glass forming apparatuses described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein and together with the description serve to explain the principles and operations of the claimed subject matter.

### BRIEF DESCRIPTION OF THE DRAWINGS

FIG. 1 schematically depicts a glass forming apparatus according to one or more embodiments shown and described herein;

FIG. 2A schematically depicts a side view of a forming body according to one or more embodiments shown and described herein;

FIG. 2B schematically depicts a cross section of the forming body of FIG. 2A;

FIG. 3A schematically depicts a side view of a forming body positioned within an enclosure and an array of thermal elements positioned above the enclosure according to one or more embodiments shown and described herein;

FIG. 3B schematically depicts an enlarged view of the circled section 3B in FIG. 3A;

FIG. 3C schematically depicts a cross-section of the forming body, enclosure and array of thermal elements of FIG. 3A;

FIG. 3D schematically depicts a partial perspective view of the forming body, enclosure, and bottom portions of thermal elements of FIG. 3A;

FIG. 4 schematically depicts a perspective view of a forming body positioned within an enclosure and thermal elements extending adjacent to side panels of the enclosure according to one or more embodiments shown and described herein;

FIG. 5 schematically depicts a partial cross section of a thermal element in the form of a cooling element according to one or more embodiments shown and described herein;

FIG. 6 schematically depicts a side view of a forming body within an enclosure, an array of thermal elements, and an array of thermal shields positioned above the enclosure according to one or more embodiments shown and described herein;

FIG. 7 schematically depicts a side view of a forming body within an enclosure, an array of thermal elements, an array of thermal shields and a support plate extending substantially parallel to weirs of the forming body according to one or more embodiments shown and described herein;

FIG. 8 schematically depicts a top view of the support plate in FIG. 7;

FIG. 9 schematically depicts a side view of the forming body within the enclosure in FIG. 5 with a plurality of heating elements and at least one cooling element;

FIG. 10A schematically depicts a side view of a forming body, an enclosure, and a heating element positioned above the enclosure according to one or more embodiments shown and described herein;

FIG. 10B schematically depicts a side view of the heating element in FIG. 10A with a single heating zone according to one or more embodiments shown and described herein;

FIG. 10C schematically depicts a side view of the heating element in FIG. 10A with two heating zones according to one or more embodiments shown and described herein;

FIG. 10D schematically depicts a side view of the heating element in FIG. 10A with three heating zones according to one or more embodiments shown and described herein;

FIG. 11A schematically depicts a side view of a forming body, an enclosure, a heating element positioned above the enclosure, and a heating element extending into an inlet end of the forming body according to one or more embodiments shown and described herein;

FIG. 11B schematically depicts a side view of the heating element in FIG. 11A with a single heating zone according to one or more embodiments shown and described herein;

FIG. 11C schematically depicts a side view of the heating element in FIG. 11A with two heating zones according to one or more embodiments shown and described herein;

FIG. 11D schematically depicts a side view of the heating element in FIG. 11A with three heating zones according to one or more embodiments shown and described herein;

FIG. 12A schematically depicts a thermal model of molten glass in a forming body with an array of thermal elements (depicted by an array of thermal element bottom portions) positioned above an enclosure surrounding the trough, according to one or more embodiments shown and described herein;

FIG. 12B schematically depicts a top view of the model of FIG. 12A showing the positions of the thermal elements above the enclosure;

FIG. 13A graphically depicts an isothermal temperature profile (ISOTHERMAL), a linearly decreasing temperature profile (Ldec), and a linearly increasing temperature profile (Linc) as a function of normalized position along a length of a forming body trough according to one or more embodiments shown and described herein;

FIG. 13B graphically depicts normalized molten glass mass flow rate over forming body weirs as a function of normalized position along the length of the forming body trough and as a function of the isothermal temperature profile (ISOTHERMAL), the linearly decreasing temperature profile (Ldec), and the linearly increasing temperature profile (Linc) shown in FIG. 13A;

FIG. 13C graphically depicts deviation of the normalized molten glass mass flow rate relative to the molten glass flow rate for the isothermal temperature profile shown in FIG. 13B for the linearly decreasing temperature profile (Ldec) and the linearly increasing temperature profile (Linc);

FIG. 14A graphically depicts temperature profiles for molten glass as a function of normalized position along a length of a forming body trough as a function of four different molten glass trough inlet temperatures (1, 2, 3, 4) according to one or more embodiments described herein;

FIG. 14B graphically depicts normalized molten glass mass flow rate over forming body weirs as a function of the temperature profiles shown in FIG. 13A (ISOTHERMAL, Ldec, Linc) and the temperature profiles shown in FIG. 14A (1, 2, 3, 4);

FIG. 14C graphically depicts normalized change in thickness of glass ribbon as a function of normalized width of the glass ribbon for the molten glass mass flows Ldec, Linc, 1, 2, 3 and 4 shown in FIG. 14B;

FIG. 15A graphically depicts normalized molten glass mass flow rate as a function of normalized position along a length of a forming body trough with local cooling applied at a top portion (TOP COOL) and a bottom portion (BOTTOM COOL) of the trough inlet end;

FIG. 15B graphically depicts normalized molten glass mass flow rate as a function of normalized position along the length of the forming body trough with local cooling applied at the trough inlet end (INLET COOL, INLET COOL 2.5×), local cooling applied at trough distal end (COMPRESSION COOL, COMPRESSION COOL 2.5×), and local heating applied to the trough inlet end (INLET HEAT);

FIG. 16A graphically depicts the response temperature of molten glass at the surface, center, and bottom of a forming body trough as a function of normalized position along a length of the forming body trough;

FIG. 16B graphically depicts the response temperature of molten glass at the surface, center, and bottom of the forming body trough as function of normalized position along the length of the forming body trough;

FIG. 17 graphically depicts temperature profiles of molten glass in a forming body trough as a function of normalized position along a length of the forming body trough and heating element configuration positioned over the forming body trough; and

FIG. 18 graphically depicts the normalized viscosity of molten glass in a forming body trough as a function of normalized position along a length of the forming body trough and heating element configuration positioned over the trough of the forming body.

### DETAILED DESCRIPTION

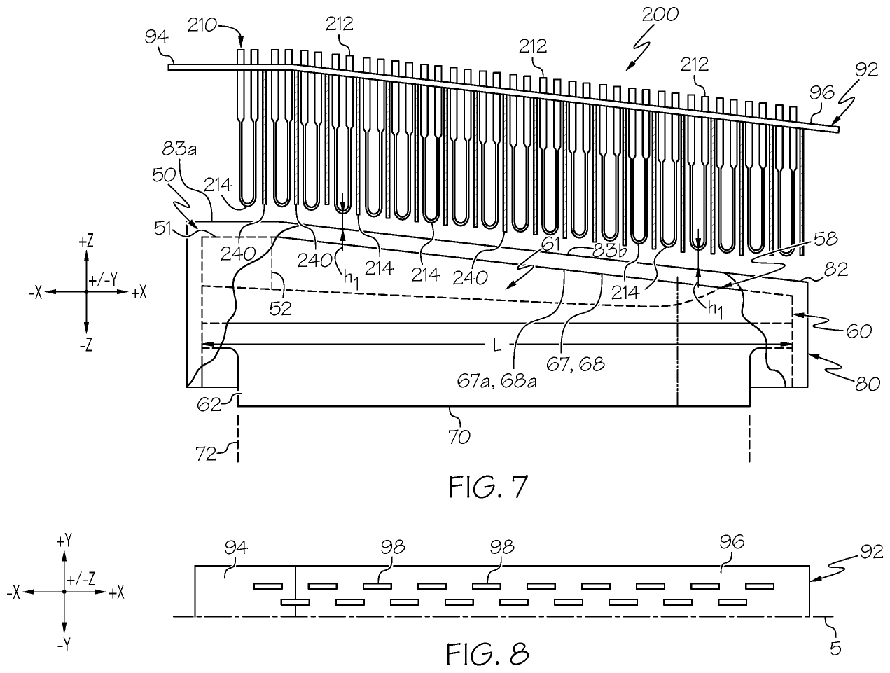

Reference will now be made in detail to embodiments of forming bodies for glass forming apparatuses, examples of which are illustrated in the accompanying drawings. Whenever possible, the same reference numerals will be used throughout the drawings to refer to the same or like parts. One embodiment of a glass forming apparatus is schematically depicted in FIG. 7. The glass forming apparatus may include a forming body with an upper portion and a first forming surface and a second forming surface extending from the upper portion and converging at a root. A trough for receiving molten glass is included in the upper portion and is defined by an inlet end, a distal compression end, a first weir, a second weir opposite and spaced apart from the first weir, and a base extending between the first weir and the second weir. The forming body is positioned within an enclosure that has a top panel and a pair of side panels. The top panel is positioned above and extends substantially parallel to and across the top surfaces of the first and second weirs along a length of the forming body. At least one thermal element is suspended from a support plate over the enclosure. For example, an array of thermal elements is suspended from the support plate over the enclosure, the array of thermal elements being operable to locally heat or cool molten glass within the trough thereby manipulating the temperature and viscosity of the molten glass along a length of the trough. The support plate is positioned above and extends substantially parallel to and across the top panel of the enclosure such that thermal elements of uniform size (i.e., length) may be used along the length of the forming body. Manipulation of the temperature and viscosity of the molten glass along a length of the trough with the at least one thermal element may provide compensation for physical dimensional changes of the forming body during a glass ribbon forming campaign. Various embodiments of glass forming apparatuses will be described in further detail herein with specific reference to the appended drawings.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

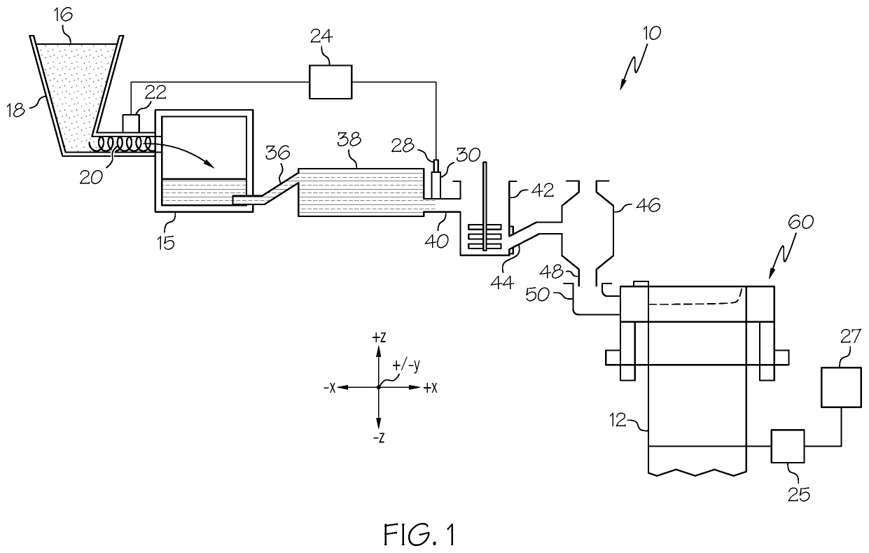

Referring now to FIG. 1, a glass forming apparatus 10 for making glass articles, such as a glass ribbon 12, is schematically depicted. The glass forming apparatus 10 may generally include a melting vessel 15 configured to receive batch material 16 from a storage bin 18. The batch material 16 can be introduced to the melting vessel 15 by a batch delivery device 20 powered by a motor 22. An optional controller 24 may be provided to activate the motor 22 and a molten glass level probe 28 can be used to measure the glass melt level within a standpipe 30 and communicate the measured information to the controller 24.

The glass forming apparatus 10 can also include a fining vessel 38, such as a fining tube, coupled to the melting vessel 15 by way of a first connecting tube 36. A mixing vessel 42 is coupled to the fining vessel 38 with a second connecting tube 40. A delivery vessel 46 is coupled to the mixing vessel 42 with a delivery conduit 44. A downcomer 48 is positioned to deliver glass melt from the delivery vessel 46 to an inlet end 50 of a forming body 60. In the embodiments shown and described herein, the forming body 60 is a fusion-forming vessel which may also be referred to as an isopipe.

The melting vessel 15 is typically made from a refractory material, such as refractory (e.g., ceramic) brick. The glass forming apparatus 10 may further include components that are typically made from electrically conductive refractory metals such as, for example, platinum or platinum-containing metals such as platinum-rhodium, platinum-iridium and combinations thereof. Such refractory metals may also include molybdenum, palladium, rhenium, tantalum, titanium, tungsten, ruthenium, osmium, zirconium, and alloys thereof and/or zirconium dioxide. The electrically conductive refractory metal containing components can include one or more of the first connecting tube 36, the fining vessel 38, the second connecting tube 40, the standpipe 30, the mixing vessel 42, the delivery conduit 44, the delivery vessel 46, the downcomer 48 and the inlet end 50.

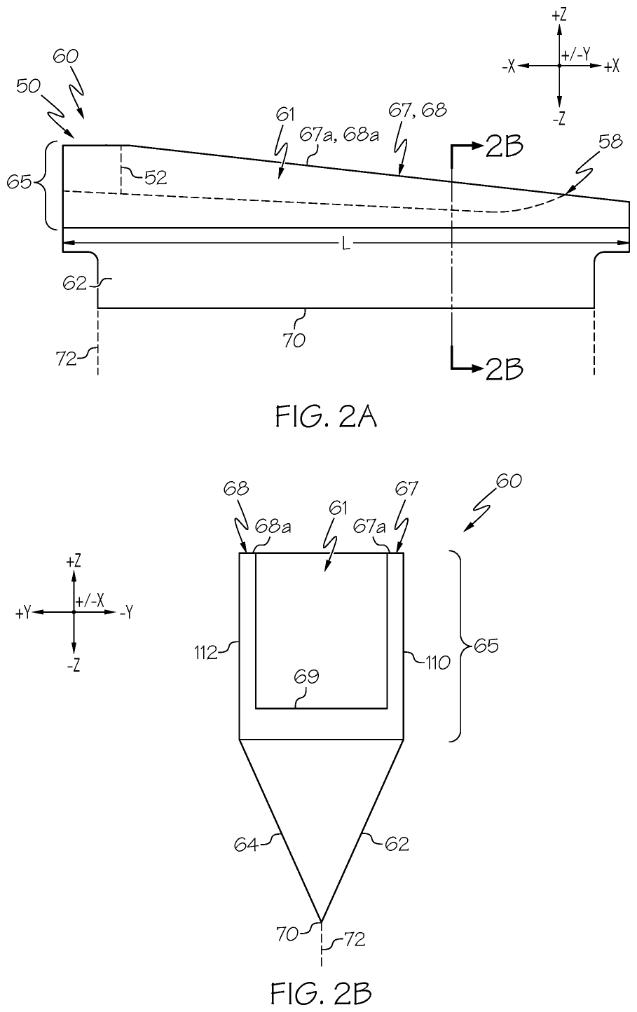

Referring now to FIGS. 1-2B, the forming body 60 comprises a trough 61 with an inlet end 52 and a distal end 58 opposite the inlet end 52. As used herein, the “distal” end of an element of the forming body 60 will be intended to refer to a downstream end of the element (relative to an upstream, or “inlet” end of the element). The trough 61 is located in an upper portion 65 of the forming body 60 and comprises a first weir 67 with a top surface 67a and an outer vertical surface 110, a second weir 68 with a top surface 68a and an outer vertical surface 112, and a base 69. The top surface 67a and top surface 68a extend along a length L of the forming body 60 and may lie in a single plane. In embodiments, the top surfaces 67a, 68a lie within a horizontal plane, i.e., the top surfaces 67a, 68a lie within the X-Y plane depicted in the figures. In other embodiments, the top surfaces 67a, 68a lie within a plane that is not horizontal, i.e., the top surfaces 67a, 68a do not lie within the X-Y plane depicted in the figures. The trough 61 may vary in depth as a function of length along the forming body. The forming body 60 may further comprise a first forming surface 62 and a second forming surface 64. The first forming surface 62 and the second forming surface 64 extend from the upper portion 65 of the forming body 60 in a vertically downward direction (i.e., the −Z direction of the coordinate axes depicted in the figures) and converge towards one another, joining at a lower (bottom) edge of the forming body 60, which may also be referred to as the root 70. Accordingly, it should be understood that the first forming surface 62 and the second forming surface 64 form an inverted isosceles (or equilateral) triangle extending from the upper portion 65 of the forming body 60 with the root 70 forming the lower-most vertex of the triangle in the downstream direction. A draw plane 72 generally bisects the root 70 in the +/−Y directions of the coordinate axes depicted in the figures and extends in the vertically downward direction (−Z direction).

Still referring to FIGS. 1-2B, in operation, batch material 16, specifically batch material for forming glass, is fed from the storage bin 18 into the melting vessel 15 with the batch delivery device 20. The batch material 16 is melted into molten glass in the melting vessel 15. The molten glass passes from the melting vessel 15 into the fining vessel 38 through the first connecting tube 36. Dissolved gasses, which may result in glass defects, are removed from the molten glass in the fining vessel 38. The molten glass then passes from the fining vessel 38 into the mixing vessel 42 through the second connecting tube 40. The mixing vessel 42 homogenizes the molten glass, such as by stirring, and the homogenized molten glass passes through the delivery conduit 44 to the delivery vessel 46. The delivery vessel 46 discharges the homogenized molten glass through downcomer 48 and into the inlet end 50 of the forming body 60, which in turn passes the homogenized molten glass into the trough 61 of the forming body 60 toward the distal end 58 of the trough 61.

The homogenized molten glass fills the trough 61 of the forming body 60 and ultimately overflows, flowing over the first weir 67 and second weir 68 of the upper portion 65 of the forming body 60 along at least a portion of its length L and then in the vertically downward direction (−Z direction). The homogenized molten glass flows from the upper portion 65 of the forming body 60 and onto the first forming surface 62 and the second forming surface 64. Streams of homogenized molten glass flowing over the first forming surface 62 and the second forming surface 64 join and fuse together at the root 70, forming a glass ribbon 12 that is drawn on the draw plane 72 in the downstream direction by pulling rolls (not shown). A thickness measurement device 25 measures the thickness of the glass ribbon 12 along the width (+/−X direction) of the glass ribbon 12. Thickness measurement values of the glass ribbon 12 along its width may be transmitted to a controller 27 and the controller 27 may adjust localized heating or cooling of molten glass flowing over the first weir 67 and second weir 68 as discussed in greater detail herein. The glass ribbon 12 may be further processed downstream of the forming body 60 such as by segmenting the glass ribbon 12 into discrete glass sheets, rolling the glass ribbon 12 upon itself, and/or applying one or more coatings to the glass ribbon 12.

The forming body 60 is typically formed from refractory ceramic materials that are chemically compatible with the molten glass and capable of withstanding the high temperatures associated with the fusion forming process. Typical materials from which the forming body is formed include, without limitation, zircon (e.g., zirconia), silicon carbide, xenotime, and/or alumina based refractory ceramics. The mass of the molten glass flowing into the trough 61 of the forming body 60 exerts an outward pressure on the first and second weirs 67, 68. This pressure, combined with the elevated temperature creep of the refractory ceramic materials that the forming body 60 is made from, can cause the first and second weirs 67, 68 to bow progressively outward (i.e., in the −Y direction for the first weir 67 and the +Y direction for the second weir 68 of the coordinate axes depicted in FIG. 2B) over the course of a glass drawing campaign which may span a period of several years. The outward bowing of the first and second weirs 67, 68 and the sag of the forming body 60, which may be non-uniform along a length L of the forming body 60, may significantly alter the glass distribution within the trough 61, e.g., by reducing glass flow over the first and second weirs 67, 68 where the bowing is most pronounced, and increasing glass flow over the first and second weirs 67, 68 where the bowing is less pronounced. The altered glass distribution may cause undesirable thickness and width variations in the resultant glass ribbon 12, which in turn may lead to process inefficiencies as glass ribbon that is out of specification is discarded. As the bowing of the first and second weirs 67, 68 or the sagging of the forming body 60 progresses with time, use of the forming body must be discontinued and the glass forming apparatus must be rebuilt.

In addition to the first and second weirs 67, 68 bowing outward, the forming body 60 can tend to sag in the downstream direction (−Z direction) along its length L due to material creep. This sag can be most pronounced at the unsupported midpoint of the length L of the forming body 60. The sag in the forming body 60 causes the homogenized molten glass flowing over the forming surfaces 62, 64 to redistribute, creating a non-uniform flow of molten glass over the forming surfaces 62, 64 which results in changes to the dimensional attributes of the resultant glass ribbon 12. For example, a thickness of the glass ribbon 12 may increase proximate the center of the glass ribbon due to sag. In addition, the redistribution of the molten glass flow towards the center of the forming surfaces 62, 64 along the length L due to sag causes a decrease in glass flow proximate the ends of the forming body 60 resulting in non-uniformity in the dimension of the glass ribbon 12 in the +/−X direction of the coordinate axes depicted in the figures.

The embodiments of the glass forming apparatuses 10 described herein compensate for the outward bowing in the first and second weirs 67, 68 and the sag of the forming body 60 thereby prolonging the service life of the forming body 60 and stabilizing the dimensional characteristics of the glass ribbon 12 formed therefrom.

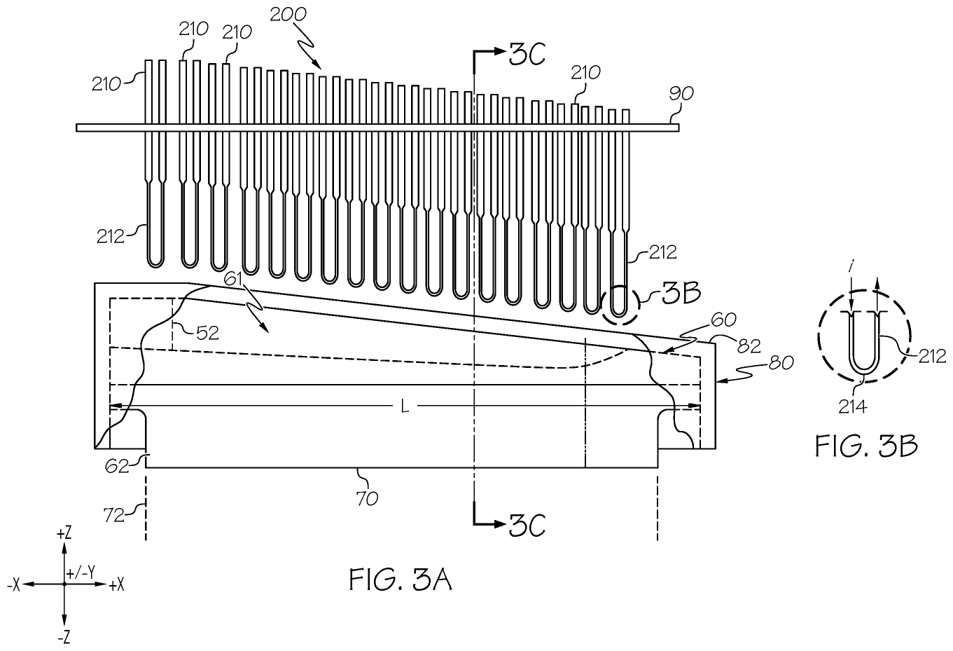

Referring now to FIGS. 3A-3D, embodiments of the glass forming apparatuses described herein include at least one thermal element positioned over the forming body 60. The thermal element is used to regulate the temperature of the molten glass along the length of the trough of the forming body, thereby controlling the viscosity of the molten glass and, hence the flow of molten glass over the weirs of the forming body. For example, in one embodiment, an array of thermal elements 200 extend along at least a portion of, or the entire, length L of the forming body 60 as shown in FIG. 3A. The array of thermal elements 200 may include a plurality of thermal elements 210 that are suspended from a support 90 and extend from the support 90 to a position above the trough 61 of the forming body 60. The array of thermal elements 200 may also extend along the width W of the forming body 60 as depicted in FIG. 3C. In embodiments, the forming body 60 may be positioned within an enclosure 80 that comprises a top panel 82, a first side panel 84 extending from the top panel 82 in the downstream direction (−Z direction) adjacent and substantially parallel to the first weir 67 and a second side panel 86 extending from the top panel 82 in the downstream direction adjacent and substantially parallel to the second weir 68. In such embodiments, the plurality of thermal elements 210 may be positioned above the enclosure 80. It is understood that the enclosure 80 prevents debris from the array of thermal elements, such as debris from blistering or scaling of a thermal element 210, from falling into the molten glass within the trough 61 and/or adhering to molten glass flowing down the outer vertical surfaces 110, 112. Accordingly, the enclosure 80 aids in reducing contamination of the molten glass and the top panel 82 provides thermal diffusion between the thermal elements 210 and the molten glass such that discrete temperature and viscosity differences in the molten glass are avoided. Suitable materials from which the enclosure 80 is formed are materials with high thermal conductivity, high emissivity and high heat resistance, illustratively including, without limitation, SiC and SiN.

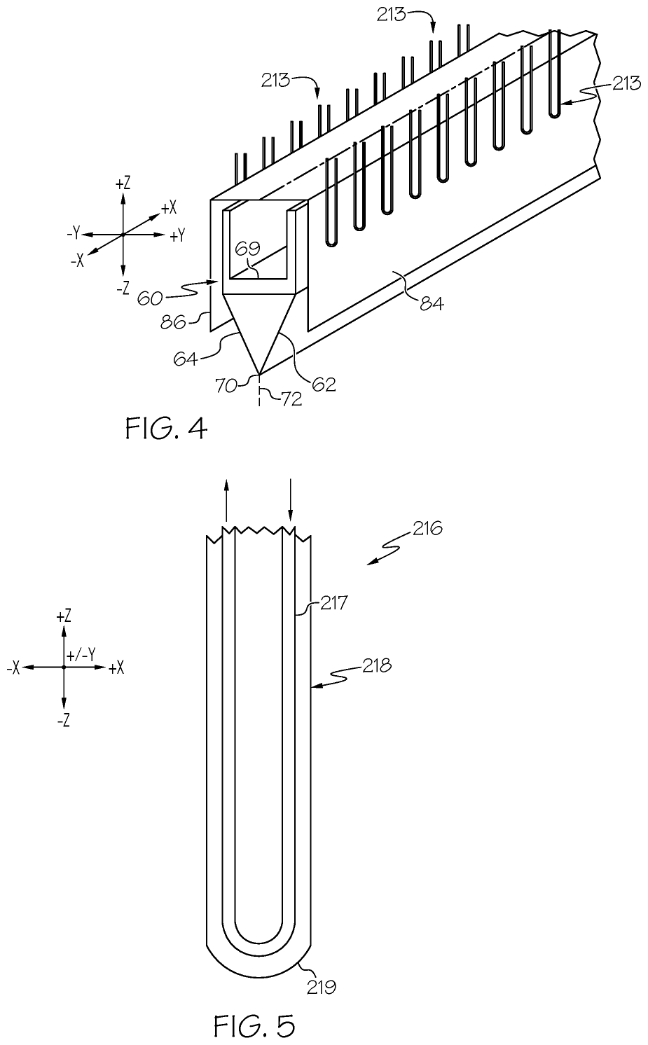

In some embodiments, the plurality of thermal elements 210 are heating elements 212 as depicted in FIGS. 3A-3B, while in other embodiments the array of thermal elements 210 are cooling elements 216 as depicted in FIG. 5. In still other embodiments, the plurality of thermal elements 210 comprise a combination of heating elements 212 and cooling elements 216. The heating elements may include a bottom portion 214 as depicted in FIG. 3B. In embodiments, the bottom portion 214 may have a U-shape with a pair of substantially parallel linear sections of the heating element 212 extending from an arcuate bottom of the heating element 212. Electric current i flowing through the heating element 212 as depicted in FIG. 3B results in resistance heating of the heating elements 212. The cooling element 216 (FIG. 5) may have an inner U-shaped tube 217 through which a cooling fluid flows. The cooling fluid may include, without limitation, gas such as nitrogen or air, a liquid coolant such as water, or the like. The inner U-shaped tube 217 may be positioned within an outer tube 218 with a closed bottom surface 219. Cooling fluid flowing through the inner U-shaped tube 217 results in convection cooling of the cooling element 216. The resistance heating of the heating elements 212 or convection cooling of the cooling elements 216 positioned along the length L of the forming body 60 provides heat or extracts heat, respectively, to molten glass within the trough 61 along the length L of the forming body 60. The resistance heating of the heating elements 212 or convection cooling of the cooling elements 216 may also provide heat or extract heat, respectively, to molten glass flowing over the first weir 67 and second weir 68 of the upper portion 65 along the length L of the forming body 60.

In the embodiment depicted in FIGS. 3A-3D, the bottom portions 214 of the heating elements 212 are positioned above (+Z direction) the top panel 82 of the enclosure 80, the trough 61 and the molten glass in the trough 61. In embodiments, the plurality of heating elements 212 may be arranged in one or more rows extending along the length L of the forming body 60 as depicted in FIG. 3D which shows just the bottom portions 214 of the heating elements 212. Each row of heating elements 212 may be symmetrical about a central axis 5 of the top panel 82 to provide uniform heating to the molten glass across the width (i.e., the +/−Y direction) of the forming body 60. In embodiments, adjacent rows of the heating elements 212 are offset or staggered from each other along the length L of the forming body 60. That is, individual heating elements 212 in one row of heating elements 212 are offset in the length direction (+X direction) relative to individual heating elements 212 in an adjacent row of heating elements 212. In other embodiments, adjacent rows of the heating elements 212 are not offset or staggered from each other along the length L of the forming body 60. That is, individual heating elements 212 in one row of heating elements 212 are not offset in the length direction (+X direction) relative to individual heating elements 212 in an adjacent row of heating elements 212.

In the embodiments described herein, each of the plurality of thermal elements 210 (heating elements 212 and/or cooling elements 216) may be independently controlled thereby enabling local heating or cooling of the molten glass in the trough 61 along the length L and the width W of the forming body 60. It should be appreciated that independent control of the plurality of thermal elements 210 enables localized control of the temperature and viscosity of the molten glass within the trough 61 and localized control of the temperature and viscosity of the molten glass flowing over the first and second weirs 67, 68 which, in turn, enables localized control of the flow of the mass flow of molten glass over the first and second weirs 67, 68 of the forming body 60.

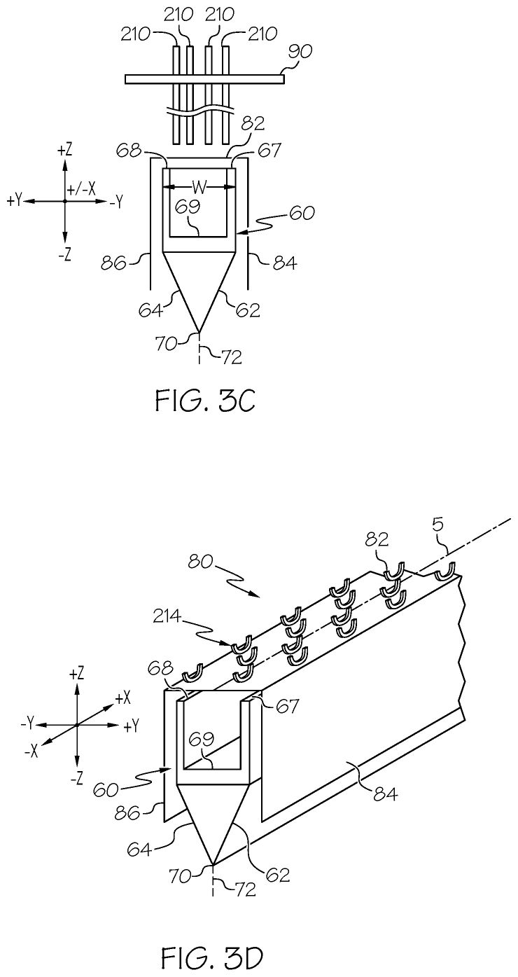

Referring now to FIGS. 3A-3D and 4, in embodiments, the array of thermal elements may further include thermal elements extending vertically (+/−Z direction) along the side of the enclosure 80. Particularly, side thermal elements 213 with a generally vertical orientation (+/31 Z direction) may extend along the first side panel 84, the second side panel 86 or both the first side panel 84 and the second side panel 86 as depicted in FIG. 4. In embodiments, the enclosure 80 is positioned between the side thermal elements 213 and the forming body 60. It is understood that the enclosure 80 aids in preventing debris from the side thermal elements 213, such as debris from blistering or scaling of a side thermal element 213, from contaminating the molten glass flowing down (−Z direction) the outer vertical surfaces 110, 112. Also, the side panels 84, 86 provide thermal diffusion between the side thermal elements 213 and the molten glass such that discrete temperature and viscosity differences in the molten glass are avoided. The one or more of the side thermal elements 213 may be positioned adjacent and substantially parallel to the first side panel 84 and the first weir 67 and/or one or more of the side thermal elements 213 may be positioned adjacent and substantially parallel to the second side panel 86 and the second weir 68. The one or more side thermal elements 213 positioned adjacent and substantially parallel to the first side panel 84, the second side panel 86 or both the first side panel 84 and the second side panel 86 may be independently controlled thereby enabling local heating of molten glass flowing over and down the first weir 67, the second weir 68 or both the first weir 67 and the second weir 68, respectively. Accordingly, it should be understood that the one or more side thermal elements may be used to regulate the temperature and viscosity of the molten glass flowing over the first weir 67 and the second weir 68 and, hence, the mass flow of the molten glass along the length L of the forming body 60. Similar to the plurality of thermal elements 210 discussed above, in embodiments, the side thermal elements 213 are heating elements, e.g. heating elements 212 as depicted in FIG. 3B, while in other embodiments, the side thermal elements 213 are cooling elements, e.g., cooling elements 216 as depicted in FIG. 5. In yet other embodiments the side thermal elements 213 comprise a combination of heating elements 212 and cooling elements 216. Resistance heating or convection cooling of the side thermal elements 213 along the length L of the forming body 60 provides heat or extracts heat, respectively, to molten glass flowing over the first and second weirs 67, 68 and/or to molten glass flowing down the outer vertical surfaces 110, 112. Although FIG. 4 depicts only side thermal elements 213 extending along the first side panel 84 and the second side panel 86, it should be appreciated that thermal elements 210 may also be positioned above the enclosure 80 as depicted in FIG. 3A, such as above top panel 82.

In embodiments, the plurality of thermal elements 210 and the side thermal elements 213 are replaceable. For example, if a thermal element 210 or a side thermal element 213 fails during a glass ribbon campaign, the failed thermal element 210 or failed side thermal element 213 can be removed and replaced with a properly functioning heating element 212, or in the alternative replaced with a properly functioning cooling element 216. It should be appreciated that the plurality of thermal elements 210 and the side thermal elements 213 may provide enhanced control of the temperature and viscosity of the molten glass within the trough 61 and manipulation of molten glass mass flow over the first and second weirs 67, 68. Such control of the temperature of the molten glass allows for compensation of physical dimension changes of the forming body, e.g. sagging of the forming body 60 or spreading of the first and second weirs 67, 68, during glass ribbon forming campaigns.

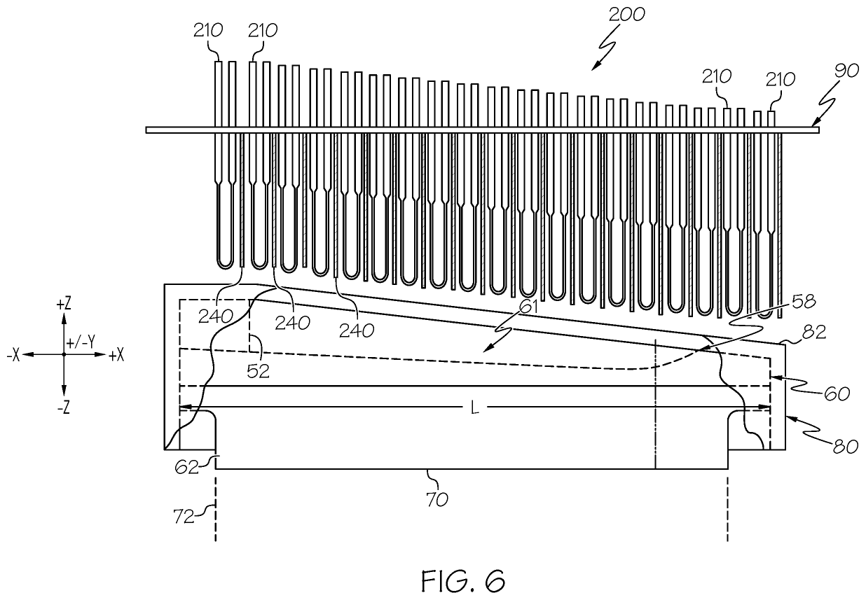

Referring now to FIG. 6, an embodiment of a forming body 60 with an array of thermal elements (e.g., heating and/or cooling elements) and an array of thermal shields is schematically depicted. Particularly, in this embodiment, the array of thermal elements 200 includes thermal shields 240 positioned between adjacent thermal elements 210. The thermal shields 240 provide radiation heat control and enhanced localization of the heating and/or cooling provided by adjacent thermal elements 210. In embodiments, the thermal shields 240 may also be positioned between side thermal elements 213 (not shown in FIG. 6) when the side thermal elements 213 are included. The thermal shields 240 may positioned between adjacent thermal elements 210 along the length L (+/−X-direction) of the forming body 60, between adjacent thermal elements 210 along the width W (+/−Y-direction) of the forming body 60 or between adjacent thermal elements 210 along both the length L and the width W of the forming body 60. It should be appreciated that the thermal shields 240 may provide enhanced control of the temperature and viscosity of the molten glass within the trough 61 and manipulation of molten glass mass flow over the first and second weirs 67, 68. Such control of the temperature of the molten glass allows for compensation of physical dimension changes of the forming body, e.g. sagging of the forming body or spreading of the weirs, during glass ribbon forming campaigns.

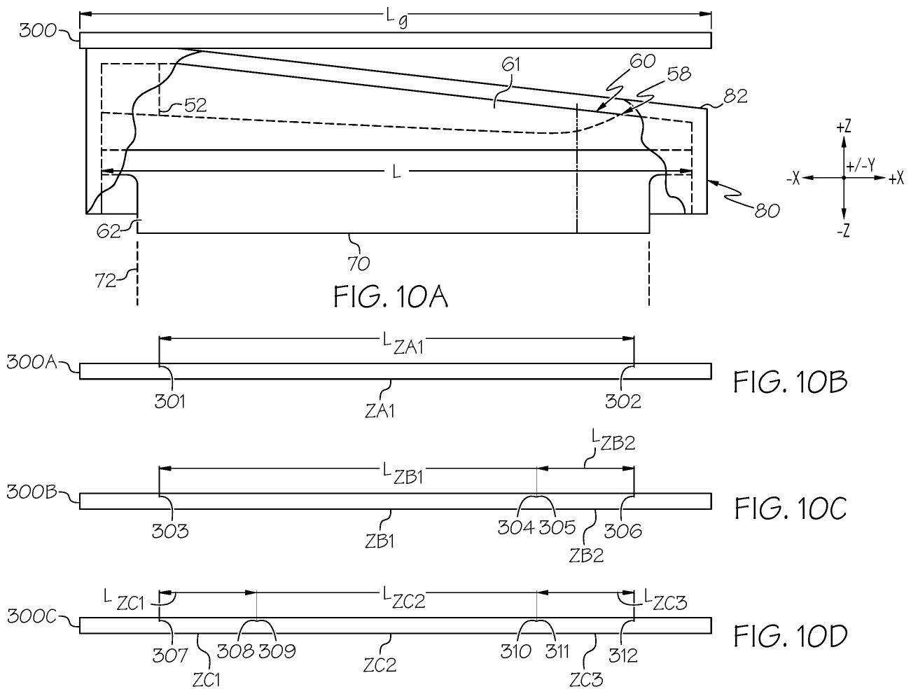

Referring now to FIGS. 7-9, an embodiment of a forming body 60 with an array of thermal elements (e.g., heating and/or cooling elements), an array of thermal shields and a support extending substantially parallel to the weirs of the forming body 60 is schematically depicted. Particularly, in this embodiment, the support from which the array of thermal elements 200 is suspended may be in the form of a support plate 92 positioned above (+Z-direction) and extending substantially parallel to and across the top surfaces 67a, 68a of the first and second weirs 67, 68, respectively, of the trough 61. The top surface 67a and top surface 68a extend along the length L of the forming body 60 and may lie within a plane. In embodiments, the top surfaces 67a, 68a lie within a horizontal plane (i.e., the X-Y plane depicted in FIGS. 7 and 9). In other embodiments, the top surfaces 67a, 68a do not lie within a horizontal plane. Accordingly, the support plate 92 may extend substantially parallel to the X-Y plane depicted in FIGS. 7 and 9, or in the alternative, the support plate 92 may not extend substantially parallel to the X-Y plane depicted in FIGS. 7 and 9, so long as the support plate 92 extends substantially parallel to the top surfaces 67a, 68a of the weirs 67, 68, respectively, along the length L of the forming body 60.

In embodiments, the top panel 82 extends across and substantially parallel to the top surfaces 67a, 68a, i.e., the top panel lies within a plane that is substantially parallel to the plane which the top surfaces 67a, 68a lie within and the support plate 92 is equidistant from the top panel 82 along the length L of the forming body 60. Accordingly, the support plate 92, top panel 82 and top surfaces 67a, 68a of the first and second weirs 67, 68, respectively, are substantially parallel to each other along the length L of the forming body 60

It should be understood that the first weir 67 and the second weir 68 may extend from the inlet end 52 of the trough 61 at an incline relative to horizontal (X-axis) as depicted in FIG. 7. As used herein, the term “incline” refers to an angle not equal to zero. For example and without limitation, the first weir 67 and the second weir 68 may extend from the inlet end 52 of the trough 61 at an angle greater than or equal to 2 degrees with respect to horizontal. In embodiments, the first weir 67 and the second weir 68 may extend from the inlet end 52 of the trough 61 at a negative incline relative to horizontal (e.g., less than or equal to −2 degrees) as depicted in FIGS. 7 and 9.

Referring particularly to FIG. 7, with the support plate 92 positioned above and extending substantially parallel to and across the top panel 82, the plurality of thermal elements 210 positioned along the length L of the forming body 60 may be of uniform size, i.e., uniform in length (Z-direction), with bottom portions 214 positioned a distance h₁ that is equidistant from the top panel 82 along the length L of the forming body 60. In embodiments, thermal shields 240 may be positioned between adjacent thermal elements 210. Specifically, the thermal shields 240 may be positioned between adjacent thermal elements 210 along the length L of the forming body 60, between adjacent thermal elements 210 along the width W of the forming body 60 or between adjacent thermal elements 210 along both the length L and the width W of the forming body 60. The thermal shields 240 provide radiation heat control and enhanced localization of the heating and/or cooling provided by adjacent thermal elements 210. In embodiments, the thermal shields 240 may also be positioned between side thermal elements 213 (FIG. 4) when the side thermal elements 213 are included. Similar to the plurality of thermal elements 210 depicted in FIG. 7 being of uniform size, the thermal shields 240 may be of uniform size (i.e., uniform length) and equidistantly spaced from the top panel 82 along the length L of the forming body 60. The uniform size of the plurality of thermal elements 210 and thermal shields 240 depicted in FIG. 7 is in contrast to the plurality of thermal elements 210 and thermal shields 240 depicted in FIGS. 3A and 6 where the support 90 extends horizontally above and non-parallel to the top panel 82 of the enclosure 80.

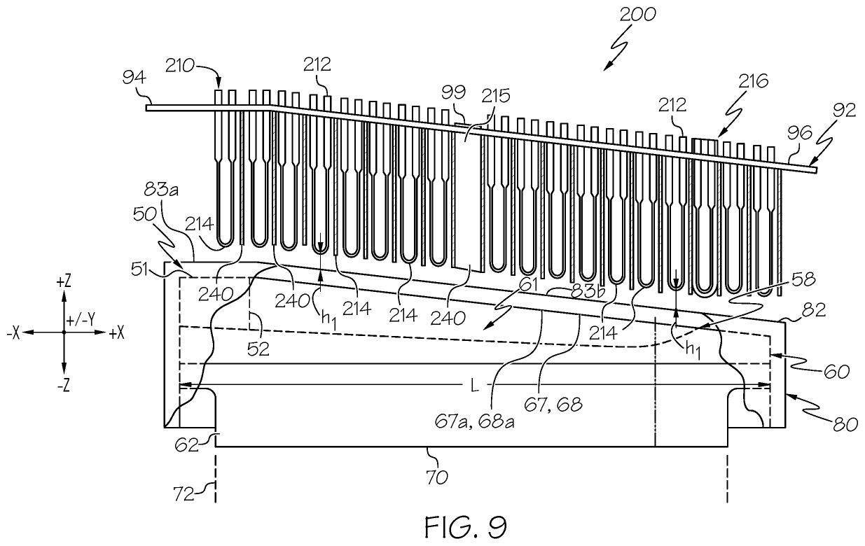

Referring particularly to FIGS. 7 and 8, the support plate 92 may have a first portion 94 that extends substantially parallel to and across a top surface 51 of the inlet end 50 of the forming body 60 and a second portion 96 that is non-linear to the first portion 94, i.e., the first portion 94 may lie within a first plane, e.g., the X-Y plane depicted in FIG. 7, and the second portion 96 may lie within a second plane that is nonparallel to the first plane. The second portion 96 lying in the second plane may extend across and substantially parallel to the top surfaces 67a, 68a of the weirs 67, 68, respectively. Similarly, the top panel 82 of the enclosure 80 may have a first section 83a that lies within the X-Y plane depicted in FIG. 7 and a second section 83b that does not lie within and is nonparallel to the X-Y plane depicted in FIG. 7. The first section 83a of the top panel 82 may extend substantially parallel to a top surface 51 of the inlet end 50 of the forming body 60 and the second section 83b may extend substantially parallel to the top surfaces 67a, 68a of the weirs 67, 68, respectively, along the length L of the forming body 60. Accordingly, in embodiments, the first portion 94 of the support plate 92, first section 83a of the top panel 82 and top surface 51 of the inlet end 50 of the forming body 60 may extend substantially parallel to each other along the length L of the forming body, and the second portion 96 of the support plate 92, second section 83b of the top panel 82 and top surfaces 67a, 68a of the weirs 67, 68, respectively, may extend substantially parallel to each other along the length L of the forming body 60.

In embodiments, the support plate 92 is formed from a single piece of material (e.g., a single piece of plate), while in other embodiments the support plate 92 is formed from at least two pieces of material. For example, the first portion 94 may be formed from a first piece of plate and the second portion 96 may be formed from a second piece of plate. In embodiments where the support plate 92 is formed from a first piece of plate and a second piece of plate, the first portion 94 may be coupled to the second portion 96 using fasteners, welding and the like. In the alternative, the first portion 94 and the second portion 96 may not be coupled together and may be individually positioned above and substantially parallel to the inlet end 50 of the forming body 60 and the top panel 82 of the enclosure 80, respectively. The support plate 92 may include a plurality of openings 98 as depicted in FIG. 8. The plurality of openings 98 may be staggered along the length (X-direction) of the support plate 92. Each of the plurality of openings 98 allow a heating element 212 or a cooling element 216 to extend through and be suspended from the support plate 92 using a hanger, collar, and the like (not shown).

Referring particularly to FIGS. 8 and 9, in some embodiments one or more of the openings 98 may have a cooling element 216 positioned therein. In the alternative, one or more of the openings 98 may not have a heating element 212 or a cooling element 216 positioned therein, i.e., one or more of the openings 98 may be vacant and covered with a lid 99. The lid 99 may prevent or reduce heat loss through an opening 98 that does not have a heating element 212 or cooling element 216 positioned therein. As depicted in FIG. 9, the thermal shields 240 positioned along both the length L and/or the width W of the forming body 60 form a plurality of hollow columns 215. For clarity in the drawings, only one hollow column 215 is labeled in FIG. 9. However it should be understood that each of the heating elements 212 and the cooling element 216 are positioned within a hollow column 215 formed by the plurality of thermal shields 240 suspended from the support plate 92 along the length L and width W of the forming body 60.

With the support plate 92 extending substantially parallel to and across the top panel 82 of the enclosure 80, the hollow columns 215 extending along the length L of the forming body 60 are of uniform cross-sectional size and volume. That is, change in the volume of the hollow columns between the support 90 and top panel 82 with increasing distance along the length L of the forming body 60 as depicted in FIG. 6 is eliminated. The uniform cross-sectional size and volume of the hollow columns 215 provide enhanced uniformity and consistency in heating and cooling molten glass in the trough 61.

The configuration of the top panel and support plate depicted in FIG. 7 provides a more compact system for heating and cooling molten glass in the trough 61 of the forming body 60 due to the support plate 92 extending substantially parallel to and across the top panel 82, and thereby extending substantially parallel to and across the top surfaces 67a, 68a of the first and second weirs 67, 68, respectively. This, in turn, reduces the weight of the system and also reduces the response time to changes in thermal settings of the thermal elements 210 when compared to systems with the support plate 92 extending horizontal (X-axis) along the length L of the trough 61 as depicted by support 90 in FIG. 6. The more compact system also has less volume above the trough 61 to heat and cool, and may result in less heat loss and thermal stress on the forming body 60 when a heating element 212 is replaced during a glass ribbon forming campaign. The support plate 92 depicted in FIG. 7 also allows for heating elements 212 and/or cooling elements 216 of uniform size to be used along the length L of the forming body 60 while providing a uniform or constant “thermal element-to-molten glass” distance along the length of the trough 61. Accordingly, the heating elements 212 and/or cooling elements 216 may have standard dimensions thereby reducing costs compared to a plurality of heating elements and/or cooling elements having different sizes used along the length L of the forming body 60. The uniform size of the thermal components 210 and the uniform cross-sectional size and volume of the hollow columns 215 may result in enhanced thermal control of the thermal elements 210 and more consistent temperature control of molten glass in the trough 61.

While FIGS. 7 and 9 depict a plurality of thermal elements 210 and a plurality of thermal shields 240 suspended from the support plate 92, it should be appreciated that the support plate 92 may be used without the plurality of thermal shields 240. That is, a plurality of thermal elements 210 may be suspended from the support plate 92 extending substantially parallel to and across the top panel 82 of the enclosure 80 without thermal shields 240 positioned between adjacent thermal elements 210. It should also be understood that a lower surface (−Z direction) of the support plate 192 may have insulation attached thereto (not shown) to protect or shield the support plate 92 from heat emanating from the trough 61 during a glass ribbon forming campaign.

In the embodiments described herein, the support 90 and support plate 92 are typically formed from metallic materials. Suitable materials from which the support 90 and support plate 92 can be formed include carbon steels, stainless steels, nickel-base alloys, etc. However, it should be understood that the support 90 and support plate 92 may be made from other materials suitable for supporting thermal elements and thermal shields above the forming body 60.

In the embodiments described herein, the heating elements 212 are typically formed from electrical resistance heating element materials. Typical materials from which the heating elements 212 can be formed may include, without limitation, lanthanum chromite (LaCrO₃), molybdenum disilicide (MoSi₂), etc. However the heating elements 212 may be made from other materials suitable for electrical resistance heating.

In the embodiments described herein, the cooling elements 216, i.e., the inner U-shaped tube 217 and the outer tube 218, are typically made from materials capable of withstanding the high temperatures encountered during production of glass ribbon illustratively including, without limitation, 310 stainless steel, Inconel® 600, etc. However, it should be understood that the cooling elements 216 may be made from other materials suitable for withstanding high temperatures.

In the embodiments described herein, the thermal shields 240 are typically formed from refractory ceramic materials. Suitable materials from which the thermal shields 240 can be formed include materials with low thermal conductivity and high heat resistance, illustratively including without limitation, SALI board. However the thermal shield 240 may be made from other materials suitable for use as high temperature insulation.

Referring now to FIGS. 1 and 3A-3D, the thermal elements 210 (heating elements 212 and cooling elements 216) may be used to locally control or regulate the temperature and viscosity of molten glass flowing over the first and second weirs 67, 68 of the forming body 60 and, hence, locally regulate or control the mass flow of molten glass flowing over the first and second weirs 67, 68. In particular, where a thickness variation is detected by the thickness measurement device 25 along the width of the glass ribbon 12 (FIG. 1), the controller 27 adjusts electrical current to the thermal elements 210 located proximate to the location of the thickness variation to alter the temperature and viscosity of the glass proximate the thermal elements, and thus the mass flow, of molten glass over the first and second weirs 67, 68, thereby mitigating dimensional variations and counteracting the effect of weir spreading. For example, outward bowing of the first and second weirs 67, 68, i.e., bowing of the first weir 67 in the +X direction and bowing of the second weir in the −X direction, results in a decrease in mass flow of molten glass where the weirs are outwardly bowed, which in turn causes thickness variations in the glass ribbon 12 in this area. By locally increasing the temperature and lowering the viscosity of molten glass in the region of outward bowing using the thermal elements 210, an increase in mass flow of molten glass over the first and second weirs 67, 68 in the region of outward bowing is provided thereby counteracting the effect of the outward bowing of the first and second weirs 67, 68.

While the foregoing example references controlled, localized heating, it should be understood that controlled, localized cooling (or a combination of heating and cooling) may also be used to counteract the effect of the outward bowing of the first and second weirs 67, 68. For example, where a thickness variation is detected by the thickness measurement device 25 along the width of the glass ribbon 12 (FIG. 1), the controller 27 adjusts the flow of cooling fluid to the thermal elements 210 located proximate to the location of the thickness variation to alter the temperature and viscosity of the glass proximate the thermal elements, and thus the mass flow, of molten glass over the first and second weirs 67, 68, thereby mitigating dimensional variations and counteracting the effect of weir spreading. Specifically, outward bowing of the first and second weirs 67, 68, i.e., bowing of the first weir 67 in the +X direction and bowing of the second weir in the −X direction, results in an increase in mass flow of molten glass away from the locations where the weirs are outwardly bowed, which in turn causes thickness variations in the glass ribbon 12 in this area. By locally decreasing the temperature and increasing the viscosity of molten glass in the region away from the bowing using the thermal elements 210, a decrease in mass flow of molten glass over the first and second weirs 67, 68 in the region away from the region of outward bowing is provided thereby counteracting the effect of the outward bowing of the first and second weirs 67, 68.

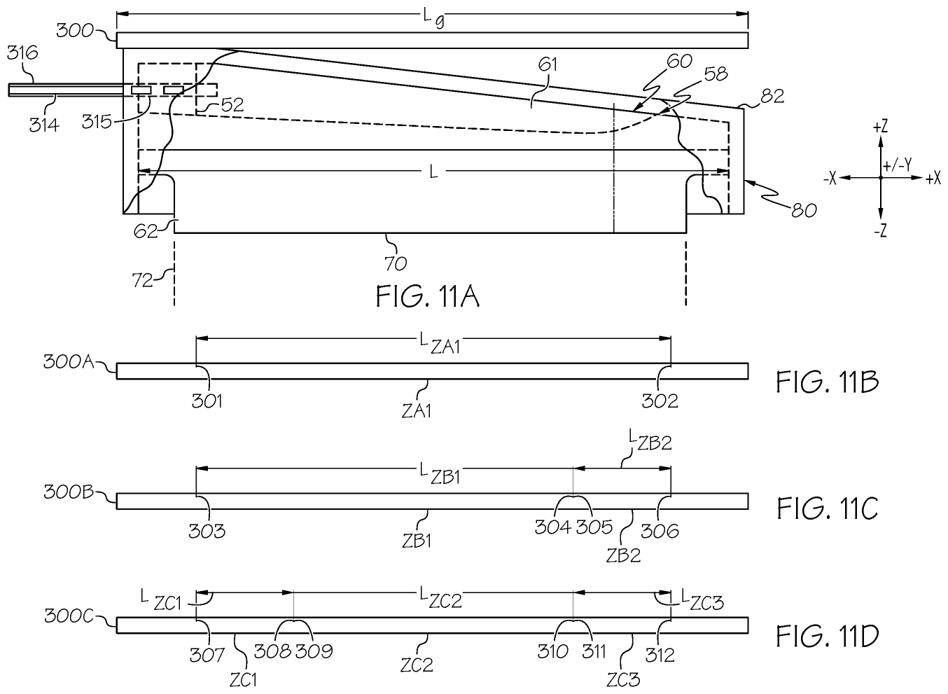

Referring now to FIGS. 1, 2A, 2B and 10A-10D, an alternative embodiment for controlling the temperature and viscosity of molten glass in the trough 61 of a forming body is depicted. Particularly, the glass forming apparatuses described herein may alternatively include a thermal element in the form of a heating element having one or more thermal zones positioned generally horizontal over or along a side the forming body 60. Particularly, a heating element 300 extending along at least a portion of the length L of the forming body 60, such as, for example, the entire length, is depicted in FIG. 10A. The heating element 300 is a generally linear heating element with a length Lg. In embodiments, at least one heating element 300 extends generally from the inlet end 52 to the distal end 58 over one of the first and second weirs 67, 68 of the trough 61 or along and adjacent to one of the outer vertical surfaces 110, 112. In embodiments, the heating element 300 is positioned substantially parallel to the root 70 of the forming body 60. Alternatively, or in addition, the heating element 300 may be positioned substantially parallel to the top panel 82 of the enclosure 80 extending over the trough 61.

In embodiments, the heating element 300 is constructed with one or more heating zones extending along its length. That is, the geometry, dimensions, and/or material of the heating element 300 may be selected such that the electrical resistance of the heating element 300 varies along its length and, hence, the resistivity of the heating element 300 varies along its length providing discrete heating zones along the length of the heating element 300. For example, FIGS. 10B-10D depict three separate embodiments for a heating element 300 positioned generally horizontal over the trough 61 of the forming body. Particularly, a heating element with a single thermal zone is depict by heating element 300A in FIG. 10B, a heating element with two thermal zones is depicted by heating element 300B in FIG. 10C, and a heating element with three thermal zones is depicted by heating element 300C in FIG. 10D. Any of the heating elements 300A, 300B, 300C, or any combination of the heating elements 300A, 300B, 300C, may be positioned above the enclosure 80 as depicted by the heating element 300 in FIG. 10A. In embodiments, one or more of the heating elements 300A, 300B, 300C may be positioned over the forming body 60 substantially parallel to the root 70 of the forming body 60 as depicted in FIG. 10A, or in the alternative, or in addition to, one or more of the heating elements 300A, 300B, 300C may be positioned substantially parallel to the top panel 82 of the enclosure 80 extending over the trough 61.

In embodiments, the heating element 300 may be in the form of the heating element 300A with a single thermal zone ZA1 as depicted in FIG. 10B. The single thermal zone ZA1 has a length L_{ZA1} and extends from an inlet end 301 positioned above (+Z direction) the inlet end 52 of the trough 61 to a distal end 302 positioned above the distal end 58 of the trough 61. The single thermal zone ZA1 has a generally uniform electrical resistance per unit length along the length L_{ZA1}. In this embodiment, the thermal zone ZA1 provides a generally uniform temperature profile along the length L_{ZA1} of the heating element 300A.

In other embodiments, the heating element 300 may be in the form of the heating element 300B with a first thermal zone ZB1 and a second thermal zone ZB2 as depicted in FIG. 10C. The first thermal zone ZB1 of the heating element 300B has a first length L_{ZB1} extending from an inlet end 303 positioned generally above (+Z direction) the inlet end 52 to a distal end 304 positioned above (+Z direction) the trough 61. The second thermal zone ZB2 of the heating element 300B has a second length L_{ZB2} extending from an inlet end 305 positioned adjacent the distal end 304 of the first thermal zone ZB1 to a distal end 306 positioned generally above (+Z direction) the distal end 58 of the trough 61. The first thermal zone ZB1 has a first electrical resistance per unit length along the first length L_{ZB1} and the second thermal zone ZB2 has a second electrical resistance per unit length along the second length L_{ZB2} different than the first electrical resistance per unit length. In this embodiment, the first thermal zone ZB1 provides a first temperature profile along the length L_{ZB1} of the heating element 300B and the second thermal zone ZB2 provides a second temperature profile different than the first temperature profile along the length L_{ZB2} of the heating element 300B. In embodiments, the first electrical resistance per unit length along the first length L_{ZB1} is greater than the second electrical resistance per unit length along the second length L_{ZB2} and the first thermal zone ZB1 has a higher average temperature than the second thermal zone ZB2. In other embodiments, the first electrical resistance per unit length along the first length L_{ZB1} is less than the second electrical resistance per unit length along the second length L_{ZB2} and the first thermal zone ZB1 has a lower average temperature than the second thermal zone ZB2.

In still other embodiments, the heating element 300 may be in the form of the heating element 300C with a first thermal zone ZC1, a second thermal zone ZC2 and a third thermal zone ZC3 as depicted in FIG. 10D. The first thermal zone ZC1 of the heating element 300C has a first length L_{ZC1} extending from an inlet end 307 positioned generally above (+Z direction) the inlet end 52 to a distal end 308 positioned above (+Z direction) the trough 61. The second thermal zone ZC2 has a second length L_{ZC2} extending from an inlet end 309 positioned adjacent the distal end 308 of the first thermal zone ZC1 to a distal end 310 positioned above (+Z direction) the trough 61. The third thermal zone ZC3 has a third length L_{ZC3} extending from an inlet end 311 positioned adjacent the distal end 310 of the second thermal zone ZC2 and a distal end 312 positioned generally above (+Z direction) the distal end 58 of the trough 61. The first thermal zone ZC1 has a first electrical resistance per unit length along the first length L_{ZC1}, the second thermal zone ZC2 has a second electrical resistance per unit length along the second length L_{ZC2} different than the first electrical resistance per unit length, and the third thermal zone ZC3 has a third electrical resistance per unit length along the third length L_{ZC3} different than the second electrical resistance per unit length. The third electrical resistance per unit length may be generally equal to, less than or greater than the first electrical resistance per unit length. In embodiments, the first thermal zone ZC1 provides a first temperature profile along the length L_{ZC1} of the heating element 300C, the second thermal zone ZC2 provides a second temperature profile different than the first temperature profile along the length L_{ZC2} of the heating element 300C, and the third thermal zone ZC3 provides a third temperature profile different than the first temperature profile and the second temperature profile along the length L_{ZC3} of the heating element 300C. In other embodiments, the first thermal zone ZC1 may provide a first temperature profile along the length L_{ZC1} of the heating element 300C, the second thermal zone ZC2 may provide a second temperature profile different than the first temperature profile along the length L_{ZC2} of the heating element 300C, and the third thermal zone ZC3 may provide a third temperature range generally the same as the first temperature profile and different than the second temperature profile along the length L_{ZC3} of the heating element 300C.

In embodiments, the first electrical resistance per unit length along the first length L_{C1} is greater than the second electrical resistance per unit length along the second length L_{ZC2}. In such embodiments, the first electrical resistance per unit length along the first length L_{ZC1} may be greater than, less than or generally equal to the third electrical resistance per unit length along the third length L_{ZC3}. For example, in embodiments, the first electrical resistance per unit length along the first length L_{ZC1} is greater than the second electrical resistance per unit length along the second length L_{ZC2} and greater than the third electrical resistance per unit length along the third length L_{ZC3}. In such embodiments, the first thermal zone ZC1 has a higher average temperature than the second thermal zone ZC2 and a higher average temperature than the third thermal zone ZC3 when the heating element 300C is one contiguous circuit and a voltage is applied to outer or extreme ends of the heating element 300C. In other embodiments, the first electrical resistance per unit length along the first length L_{ZC1} is greater than the second electrical resistance per unit length along the second length L_{ZC2} and less than the third electrical resistance per unit length along the third length LZC3. In such embodiments, the first thermal zone ZC1 has a higher average temperature than the second thermal zone ZC2 and a lower average temperature than the third thermal zone ZC3 when current flows through the heating element 300C. In still other embodiments, the first electrical resistance per unit length along the first length L_{ZC1} is greater than the second electrical resistance per unit length along the second length L_{ZC2} and generally equal to the third electrical resistance per unit length along the third length L_{ZC3}. In such embodiments, the first thermal zone ZC1 has a higher average temperature than the second thermal zone ZC2 and a generally equal average temperature as the third thermal zone ZC3 when current flows through the heating element 300C when the heating element 300C is one contiguous circuit and a voltage is applied to outer or extreme ends of the heating element 300C.

In embodiments, the first electrical resistance per unit length along the first length L_{ZC1} is less than the second electrical resistance per unit length along the second length L_{ZC2}. In such embodiments, the first electrical resistance per unit length along the first length L_{ZC1} may be greater than, less than or generally equal to the third electrical resistance per unit length along the third length L_{ZC3}. For example, in embodiments, the first electrical resistance per unit length along the first length L_{ZC1} is less than the second electrical resistance per unit length along the second length L_{ZC2} and greater than the third electrical resistance per unit length along the third length L_{ZC3}. In such embodiments, the first thermal zone ZC1 has a lower average temperature than the second thermal zone ZC2 and a higher average temperature than the third thermal zone ZC3 when current flows through the heating element 300C. In other embodiments, the first electrical resistance per unit length along the first length L_{ZC1} is less than the second electrical resistance per unit length along the second length L_{ZC2} and less than the third electrical resistance per unit length along the third length L_{ZC3}. In such embodiments, the first thermal zone ZC1 has a lower average temperature than the second thermal zone ZC2 and a lower average temperature than the third thermal zone ZC3 when current flows through the heating element 300C. In still other embodiments, the first electrical resistance per unit length along the first length L_{ZC1} is less than the second electrical resistance per unit length along the second length L_{ZC2} and generally equal to the third electrical resistance per unit length along the third length L_{ZC3}. In such embodiments, the first thermal zone ZC1 has a lower average temperature than the second thermal zone ZC2 and a generally equal average temperature as the third thermal zone ZC3 when current flows through the heating element 300C. It is understood that heating element thermal zones with higher average temperatures compared to adjacent thermal zones may be desired at particular positions or regions along a length of a forming body trough. For example, outward bowing of forming body weirs may be more pronounced at regions proximate an inlet end of the forming body trough. Accordingly, heating element thermal zones with a higher average temperature may be preferred proximate the inlet end in order to reduce the viscosity and thereby increase the mass flow of molten glass along such regions.

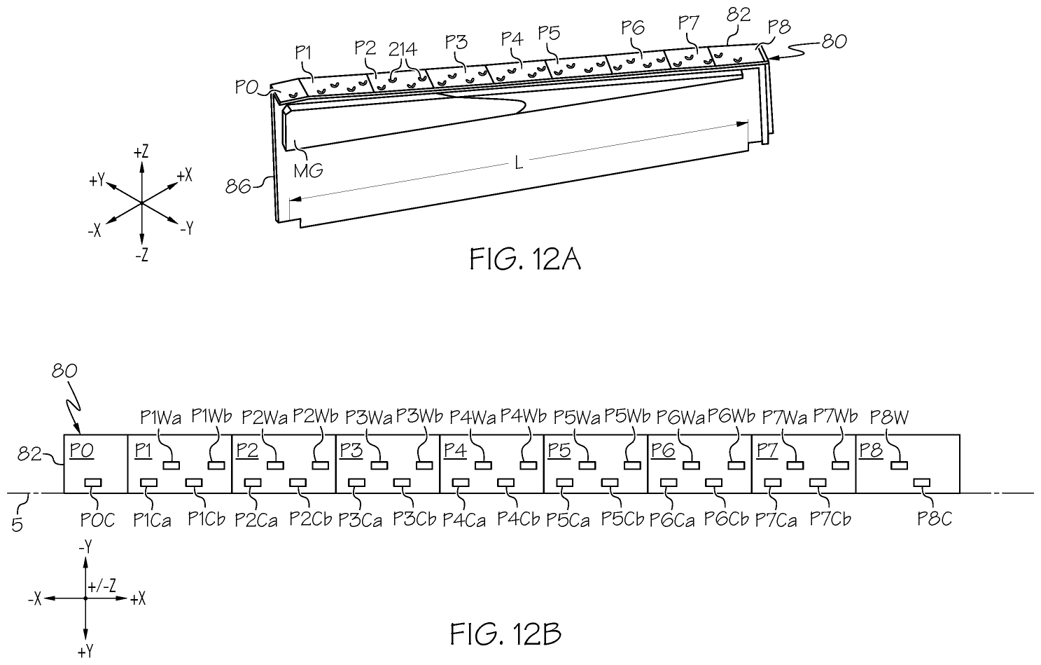

The heating element 300 as depicted in FIG. 10A may be combined with a thermal element positioned within the inlet end 52 of the forming body 60 as depicted in FIG. 11A. Particularly, the heating element 300 extends over the trough 61 along the length L of the forming body 60 as shown and described with reference to FIG. 10A and a thermal element 314 is positioned within a channel 315 formed in the forming body 60 proximate the inlet end 52 as depicted in FIG. 11A. In embodiments, the thermal element 314 may be positioned within a sleeve 316 that extends into the forming body 60 proximate the inlet end 52. In other embodiments, the thermal element 314 may be positioned within the sleeve 316 and extends into the forming body 60 through the inlet end 52 and into molten glass within the trough 61. The thermal element 314 provides an additional source of temperature control of the molten glass within the trough 61, particularly molten glass proximate to the inlet end 52. In embodiments the thermal element 314 is a heating element, e.g., a heating element similar or identical to the heating elements 212 or heating element 300 discussed herein. In other embodiments the thermal element 314 is a cooling element, e.g., a cooling element similar or identical to the cooling element 216 discussed herein.

The heating element 300 and the thermal element 314 (when in the form of a heating element) are typically formed from known high temperature electrical resistance heating element materials. Suitable materials from which the heating element 300 and the thermal element 314 (when in the form of a heating element) are formed include materials with high heat resistance, illustratively including without limitation, lanthanum chromite (LaCrO₃), molybdenum disilicide (MoSi₂), silicon carbide (SiC), etc. However the heating element 300 and the thermal element 314 may be made from other materials suitable for electrical resistance heating.

When the thermal element 314 is in the form of a cooling element, the thermal element 314 is typically formed from materials capable of withstanding high temperatures encountered during production of glass ribbon. Typical materials from which the forming body is formed may include, without limitation, 310 stainless steel, Inconel® 600, etc. However the thermal element 314 in the form of a cooling element may be made from other high temperature resistant materials suitable for withstanding the high temperatures encountered during production of glass ribbon.

Referring now to FIGS. 10A-11D, the heating element 300 may be used to locally control or regulate the temperature and viscosity of molten glass flowing over the first and second weirs 67, 68 of the forming body 60 and, hence, locally regulate or control the mass flow of molten glass flowing over the first and second weirs 67, 68. In particular, where a thickness variation is detected by the thickness measurement device 25 along the width of the glass ribbon 12, the controller 27 adjusts electrical current to the heating element 300. The adjusted electrical current increases or decreases heat provided by individual heating zones of the heating element 300 to locally alter the mass flow of molten glass over the first and second weirs 67, 68, thereby mitigating dimensional variations and counteracting the effect of weir spreading. For example, outward bowing (e.g., outward bowing in the +X direction for first weir 67 and outward bowing in the −X direction for second weir 68) results in a decrease in mass flow of molten glass which in turn may cause thickness variations in the glass ribbon 12. By locally increasing the temperature and lowering the viscosity of molten glass in a region of outward bowing using the heating element 300, an increase in mass flow of molten glass over the first and second weirs 67, 68 in the outward bowing region is provided thereby counteracting the outward bowing of the first and second weirs 67, 68.

While embodiments of the heating element 300 have been shown as stand-alone embodiments, it should be understood that the heating element 300 may be used in conjunction with the plurality of thermal elements 210, the side thermal elements 213 or both the plurality of thermal elements 210 and the side thermal elements 213 depicted in FIGS. 3A-4, 6 and 7.

### EXAMPLES

The embodiments described herein will be further clarified by the following examples.

### Example 1

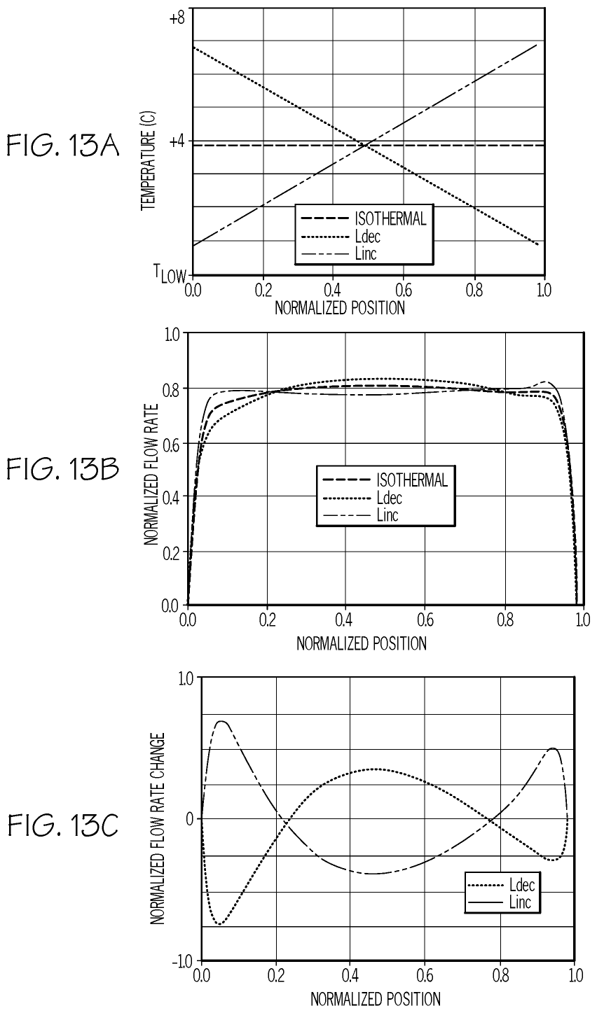

Referring to FIGS. 1-7 and 12A-13C, mathematical models were developed for an array of heating elements 212 positioned above the trough 61 of the forming body 60. Particularly, FIG. 12A schematically depicts a symmetric section along the length (+/−X direction) and about the central axis 5 (FIG. 3D) of the top panel 82 of the enclosure 80 with a plurality of bottom portions 214 of the heating elements 212 positioned above the top panel 82. The top panel 82 is above (+Z direction) the molten glass MG within the trough 61 (FIG. 2B). The molten glass MG flows over the first and second weirs 67, 68 (FIG. 2B), down the first forming surface 62 and the second forming surface 64 (FIG. 2B), and joins and fuses together at the root 70 (FIG. 2B) to form glass ribbon 12 (FIG. 1). The top panel 82 has eight panels (P0, P1, P2, . . . P8) along the length L of the forming body 60. The bottom portions 214 of the heating elements 212 are positioned with respect to a given panel (FIG. 12A). For purposes of description, each heating element 212 has been assigned a unique identifier (label) in the form of a four digit alpha numeric character ‘Pxyz’ where ‘x’ identifies the panel a heating element 212 is positioned over, ‘y’ identifies whether a heating element 212 is positioned proximate to the central axis 5 of the enclosure 80 (‘C’) or proximate the second weir 68 (‘W’), and ‘z’ corresponds to whether a heating element 212 is positioned proximate the inlet end 52 (‘a’) or the distal end 58 (‘b’) of the trough 61. For example, four heating elements 212 are positioned over panel P1 in FIG. 12B. The two heating elements 212 positioned proximate the weir are identified as ‘P1W’ with the heating element 212 positioned proximate the inlet end 52 identified as ‘P1Wa’ and the heating element 212 positioned proximate the distal end 58 identified as ‘P1Wb.’ The two heating elements 212 positioned proximate the central axis 5 are identified as ‘P1C’ with the heating element 212 positioned proximate the inlet end 52 identified as ‘P1Ca’ and the heating element 212 positioned proximate the distal end 58 identified as ‘P1Cb.’ The panel P0 only has one heating element 212 which is positioned proximate the central axis 5 and identified as ‘POC.’ The panel P8 only has two heating elements 212, one positioned proximate the weir and identified as ‘P8W’ and one positioned proximate the central axis 5 and identified as ‘P8C.” The remaining panels, i.e., panels P2, P3, P4 . . . P7, have four heating elements 212 positioned there above, and the four heating elements 212 positioned above each panel are identified with the same convention described above for panel P1.

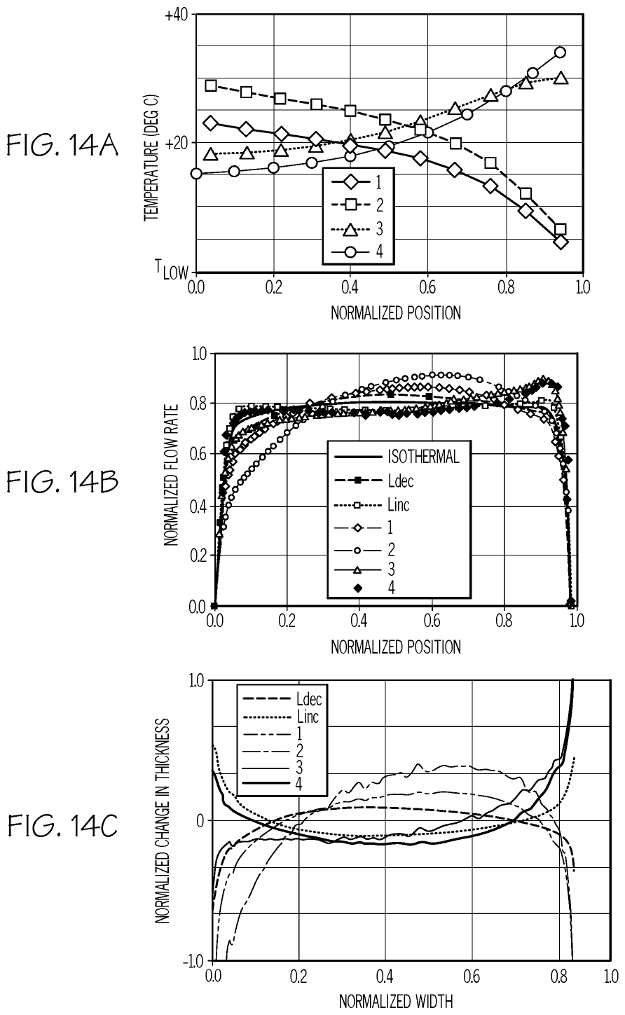

Referring to FIGS. 13A-13C, three temperature profiles provided by the thermal elements 210 along the length of the trough 61 (labeled as “NORMALIZED POSITION” in the figures) depicted in FIGS. 12A-12B are shown in FIG. 13A, normalized mass flow rate distributions of molten glass over the second weir 68 corresponding to the three temperature profiles shown in FIG. 13A are depicted in FIG. 13B, and normalized change in mass flow rate distributions relative to the normalized mass flow rate distribution for the isothermal temperature profile shown in FIG. 13A is depicted in FIG. 13C. The normalized position ‘0’ corresponds to the inlet end 52 of the trough 61 and the normalized position 1.0 corresponds to the distal end 58 of the trough 61.

FIG. 13A graphically depicts an isothermal profile (labeled ‘ISOTHERMAL’) with a temperature of the molten glass along the entire length of the trough 61 being about 4° C. above a reference temperature ‘T_{LOW}’; a linearly decreasing profile (labeled ‘Ldec’) with an inlet end 52 temperature of about 7° C. above T_{low} and a distal end 58 temperature of about 1° C. above T_{low}; and a linearly increasing profile (labeled line) with an inlet end 52 temperature of about 1° C. above T_{low} and a distal end 58 temperature of about 7° C. above T_{low}.

FIG. 13B graphically depicts the normalized mass flow rate distribution as a function of normalized position along the length of the trough 61 for molten glass MG flowing over the second weir 68 for the three temperature profiles depicted in FIG. 13A. The normalized mass flow rate distribution corresponding to the ISOTHERMAL temperature profile depicted in FIG. 13A (labeled ‘ISOTHERMAL’) is generally uniform at normalized positions between about 0.2 to about 0.9 along the length of the trough 61 with a normalized mass flow rate distribution of about 0.8. The normalized mass flow rate distribution decreases relative to 0.8 near the inlet end 52 and the distal end 58 of the trough 61. The normalized mass flow rate distribution corresponding to the Ldec temperature profile depicted in FIG. 13A (labeled ‘Ldec’), in comparison to the ISOTHERMAL normalized mass flow rate distribution, has a reduced mass flow rate distribution near the inlet end 52, an increased mass flow rate distribution between the normalized positions of about 0.2 to about 0.8, and a decreased mass flow rate distribution near the distal end 58 of the trough 61. The normalized mass flow rate distribution corresponding to the Linc temperature profile depicted in FIG. 13A (labeled ‘Linc’), in comparison to the ISOTHERMAL normalized mass flow rate distribution, has an increased mass flow rate distribution near the inlet end 52, a reduced mass flow rate distribution between the normalized positions of about 0.2 to about 0.8, and an increased mass flow distribution near the distal end 58 of the trough 61.

FIG. 13C graphically depicts the change in the Ldec normalized mass flow rate distribution and the Linc normalized mass flow rate distribution compared to the ISOTHERMAL normalized mass flow rate distribution in FIG. 13B. Particularly, the Ldec normalized mass flow distribution compared to the ISOTHERMAL normalized mass flow rate distribution has a decreased mass flow rate distribution for normalized positions between about 0.0 to about 0.2 (a maximum difference of about −0.75 at about 0.05), an increased mass flow rate distribution between about 0.2 to about 0.8 (a maximum difference of about +0.3 at about 0.5) and a decreased mass flow rate distribution between about 0.8 to about 1.0 (a maximum difference of about −0.25 at about 0.95). The Linc normalized mass flow rate distribution compared to the ISOTHERMAL normalized mass flow rate distribution has an increased mass flow rate distribution for normalized positions between about 0.0 to about 0.2 (a maximum difference of about +0.7 at about 0.05), a decreased mass flow rate distribution between about 0.2 to about 0.8 (a maximum difference of about −0.3 at about 0.5) and an increased mass flow between about 0.8 to about 1.0 (a maximum difference of about +0.5 at about 0.95). Accordingly, FIGS. 13A-13C demonstrate different temperature profiles along the length of the trough 61 result in different mass flow rate distributions (over the second weir 68) along the length L of the forming body 60. It should be appreciated that mass flow rate distributions over the first weir 67 would mirror the mass flow distributions over the second weir 68.

### Example 2

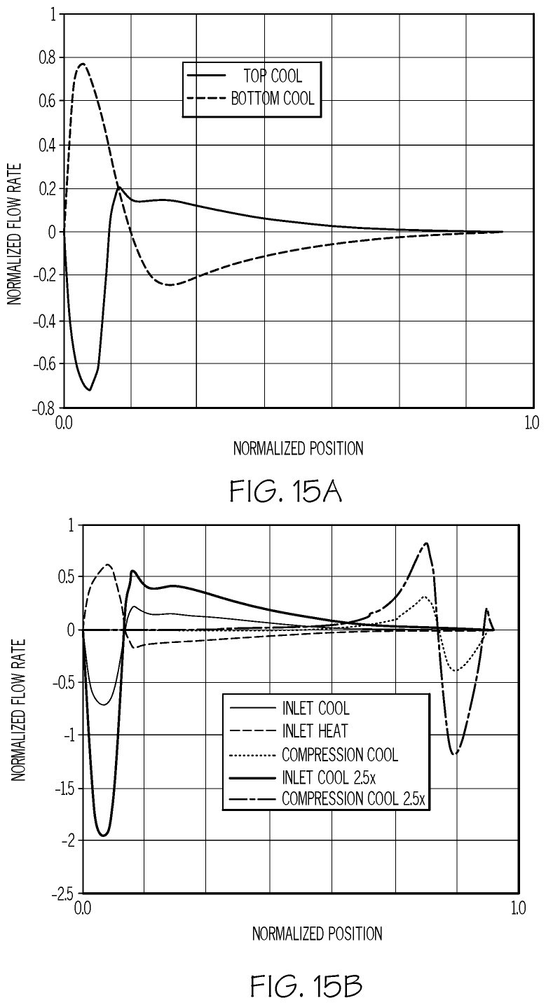

Referring now to FIGS. 1-7, 12A-12B and 14A-14C, the effect of changes in molten glass temperature along the length of the trough 61 on the mass flow rate distribution of the molten glass MG is shown. Particularly, FIG. 14A graphically depicts four molten glass MG temperature profiles (labeled 1, 2, 3, 4 in FIG. 14A). The four temperature profiles 1, 2, 3, 4 for the molten glass MG are for four different inlet end temperatures and heating along the normalized length of the trough 61 using three side thermal elements 213 (FIG. 4) in the form of heating elements 212 positioned along the second side panel 86 depicted in FIG. 12A. The three side thermal elements 213 are positioned adjacent panels P1, P2, P3 near the inlet end 50 of the forming body 60 and are identified as SU1, SU2, SU3 (Table 1) with the side heating element SU1 positioned adjacent panel P1, side heating element SU2 positioned adjacent panel P2, and side heating element SU3 positioned adjacent panel P3. The modeled power settings for the three side heating elements SU1, SU2, SU3 and inlet end temperatures above a reference temperature ‘T_{LOW}’ (labeled ‘T-in’) for the four temperature profiles 1, 2, 3, 4 are shown in Table 1.

TABLE 1

| | Profile 1 | Profile 2 | Profile 3 | Profile 4 |
|---|---|---|---|---|
| SU1 (W) | 7780 | 7780 | 10815 | 9900 |
| SU2 (W) | 7670 | 7670 | 10815 | 9900 |
| SU3 (W) | 26000 | 26000 | 26000 | 26000 |
| T-in (° C.) | +24° C. | +30° C. | +18° C. | +15° C. |

Referring to FIG. 14A, the inlet end temperature for the first temperature profile ‘1’ is about 24° C. above the reference temperature ‘T_{LOW}’ shown in the figure and the temperature of the molten glass MG steadily decreases to a temperature of about 4° C. above T_{LOW} at a normalized position of about 0.95 from the inlet end 52. The inlet end temperature for the second temperature profile ‘2’ is about 30° C. above T_{LOW} and the temperature profile of the molten glass MG steadily decreases to a temperature of about 6° C. above T_{LOW} at a normalized position of about 0.95 from the inlet end 52. The inlet end temperature for the third temperature profile ‘3’ is about 18° C. above T_{LOW} and the temperature profile for the molten glass MG steadily increases to a temperature of about 35° C. above T_{LOW} at a distance of about 0.95 from the inlet end 52. The inlet end temperature for the fourth temperature profile ‘4’ is about 15° C. above T_{LOW} and the temperature profile for the molten glass MG steadily increases to a temperature of about 34° C. at a distance of about 0.95 from the inlet end 52.

Normalized mass flow rate distributions corresponding to the four temperature profiles (1, 2, 3, 4) depicted in FIG. 14A and the three temperature profiles (ISOTHERMAL, Ldec, Linc) depicted in FIG. 13A are shown in FIG. 14B. The normalized mass flow rate distributions for the temperature profiles ‘1’ and ‘2’ are generally less than the normalized mass flow rate distributions for the temperature profiles ISOTHERMAL, Ldec, and Linc for normalized positions between about 0.05 and about 0.2. The normalized mass flow rate distributions for the temperature profiles ‘3’ and ‘4’ are generally greater than the normalized mass flow distributions for the temperature profiles ISOTHERMAL, Ldec, and Linc between about 0.8 and about 0.95. In comparison to the ISOTHERMAL temperature profile, temperature profiles ‘1’ and ‘2’ result in an increase in molten glass mass flow generally in the middle of first and second weirs 67, 68 and temperature profiles ‘3’ and ‘4’ result in an increase in molten glass mass flow generally at the ends of first and second weirs 67, 68. Accordingly, FIG. 14B illustrates controlling the temperature profile of molten glass in the trough 61 may be used to alter the molten glass mass flow as a function of position over the first and second weirs 67, 68. Control of the temperature profile and molten glass mass flow as a function of position over the weirs of a forming body may provide compensation for dimensional changes, e.g., compensation for outward bowing of the weirs of the forming body, compensation for different mass flow characteristics of different glasses during a glass ribbon campaign run, and the like.

FIG. 14C graphically depicts the corresponding change in glass ribbon thickness along the normalized width of glass ribbon 12 formed from molten glass with temperature profiles Ldec, Lin, ‘1, ‘2’, ‘3’ and ‘4’ depicted in FIGS. 13A and 14A compared to the thickness along the normalized width of glass ribbon 12 formed from molten glass with the ISOTHERMAL temperature profile depicted in FIG. 13A. The thickness values as a function of normalized width shown in FIG. 14C are for the thickness of the glass ribbon 12 at a fixed distance (−Z direction) below the root 70 of the forming body 60. Compared to the glass ribbon thickness corresponding to the ISOTHERMAL mass flow rate shown in FIG. 14B, the temperature profiles Linc and ‘4’ result in an increase in the thickness of the glass ribbon 12 for normalized positions between about 0.0 to about 0.2, a decrease in thickness for normalized positions between about 0.2 to about 0.7, and an increase in thickness for normalized positions greater than about 0.7. The temperature profiles Ldec, ‘1’ and ‘2’ result in a decrease in thickness of the glass ribbon 12 for normalized positions between about 0.0 and 0.2, an increase in glass ribbon thickness for normalized positions between about 0.2 and about 0.8, and a decrease in glass ribbon thickness for normalized positions greater than about 0.8. The temperature profile ‘3’ results in a decrease in thickness of the glass ribbon 12 for normalized positions between about 0.0 and about 0.6 and an increase in thickness of the glass ribbon 12 for normalized positions greater than about 0.6. Accordingly, FIGS. 14A-14C demonstrate temperature control along the length of the trough 61 using side thermal elements 213 provides control of glass ribbon thickness along the width of the glass ribbon.

### Example 3

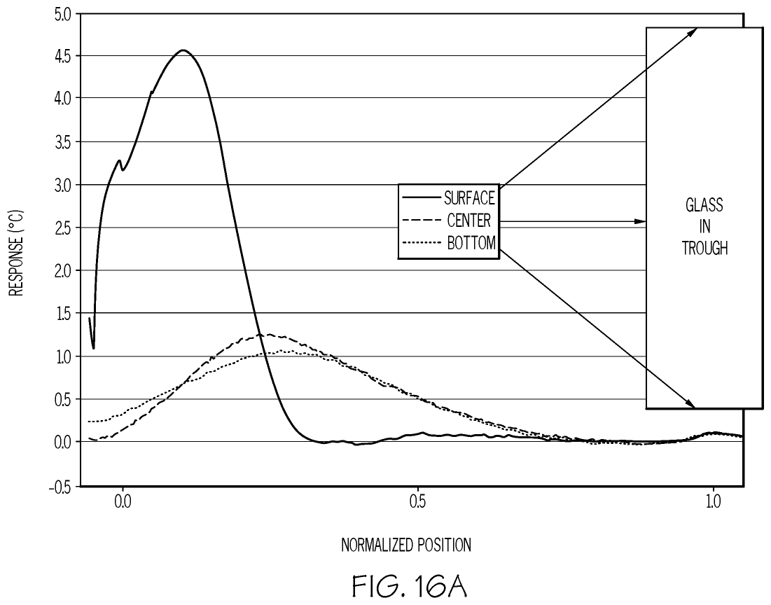

Referring to FIGS. 1-7, 12A-12B and 15A-15B, another example of changes in temperature along the length of the trough 61 affecting mass flow of molten glass is shown. Particularly, FIG. 15A graphically depicts mass flow distributions corresponding to local cooling of a top portion of molten glass MG within the trough 61 at the inlet end 52 by about 30° C. (labeled ‘TOP COOL’) and local cooling of a bottom portion of molten glass MG within the trough 61 at the inlet end 50 by about 30° C. (labeled ‘BOTTOM COOL’). In embodiments, the top portion of molten glass MG at the inlet end 52 is cooled with one or more cooling elements 216 and the bottom portion of molten glass MG at the inlet end 52 is cooled with a thermal element 314 in the form of a cooling element 216. Local cooling of about 30° C. of the top portion of molten glass MG at the inlet end 50 (TOP COOL) results in a decrease in normalized mass flow rate at the inlet end 50 (a maximum decrease of about −0.7 at about 0.05) and local cooling of about 30° C. of the bottom portion of molten glass MG at the inlet end 50 (BOTTOM COOL) results in an increase in mass flow at the inlet end 50 (a maximum increase of about +0.8 at about 0.05).

FIG. 15B graphically depicts normalized mass flow rate distributions for local cooling and local heating of the top portion of molten glass MG at the inlet end 52 and the distal end 58 of the trough 61. Mass flow rate distributions along the length of the trough 61 (labeled as “NORMALIZED POSITION”) are shown for local cooling of about 30° C. of molten glass MG at the inlet end 50 (labeled ‘INLET COOL’), local heating of about 30° C. of molten glass MG at the inlet end 50 (labeled ‘INLET HEAT’), local cooling of about 30° C. of molten glass MG at the distal end 58 (labeled ‘COMPRESSION COOL’), local cooling of about 75° C. of molten glass MG at the inlet end 52 (labeled ‘INLET COOL 2.5×’), and local cooling of about 75° C. of molten glass MG at the distal end 58 (labeled ‘COMPRESSION COOL 2.5×’). Similar to the mass flow distributions depicted in FIG. 15A, local cooling of about 30° C. of molten glass MG at the inlet end 52 results in a decrease in mass flow at the inlet end 52 (a maximum decrease of about −0.7 at about 0.05) and local heating of about 30° C. at the inlet end 52 results in an increase in mass flow at the inlet end 52 (a maximum increase of about +0.6 at about 0.05). Local cooling of about 75° C. at the inlet end 52 results in more than 2.5× decrease in mass flow at the inlet end 52 (a maximum decrease of about 2.0 at about 0.05). Local cooling of about 30° C. at the distal end 58 results in a decrease in mass flow at the distal end 58 (a maximum decrease of about −0.4 at about 0.9), but also results in an increase in mass flow at the distal end 58 (a maximum increase of about +0.25 at about 0.85). Similarly, local cooling of about 75° C. at the distal end 58 results in a decrease in mass flow at the distal end 58 (a maximum decrease of about −1.2 at about 0.9), but also results in an increase in mass flow at the distal end 58 (a maximum increase of about +0.8 at about 0.85). Accordingly, FIGS. 15A-15B demonstrate that heating and cooling at the inlet end 52 and distal end 58 of the trough 61 provides mass flow control of molten glass MG flowing over the first and second weirs 67, 68.

### Example 4

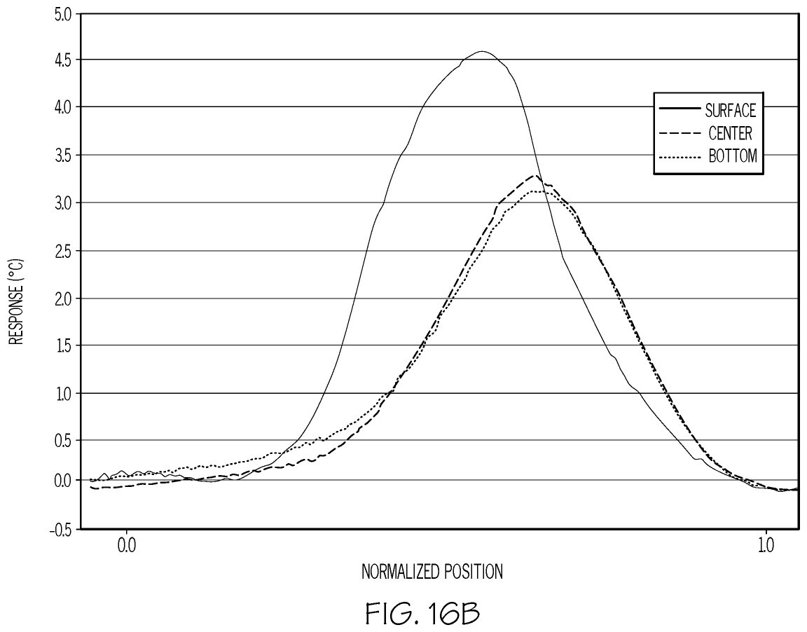

Referring to FIGS. 1-7, 12A-12B and 16A-16B, an example of changes in power settings for individual heating elements 212 depicted in FIG. 12B affecting the temperature of the molten glass MG in the trough 61 are shown in FIGS. 16A-16B. Particularly, FIG. 16A graphically depicts the temperature response of molten glass MG at surface, center, and bottom portions in the trough 61 as a function of distance along the length of the trough 61 (labeled as “NORMALIZED POSITION”) resulting from the change in power settings for the heating elements 212 shown in Table 2. The inset shown in FIG. 16A depicts the relative orientations of the surface, center and bottom portions of the molten glass MG in the trough 61. FIG. 16B graphically depicts the temperature response of molten glass MG at surface, center, and bottom portions in the trough 61 as a function of distance along the length of the trough 61 (labeled as “NORMALIZED POSITION”) resulting from the change in power settings shown for the heating elements 212 shown in Table 3.

TABLE 2

| | Power | | Power |
|---|---|---|---|
| Heating | Change | Heating | Change |
| Element | (W) | Element | (W) |
| P0C | 100 | | |
| P1Ca | 100 | P1Wa | 100 |
| P1Cb | 100 | P1Wb | 100 |
| P2Ca | −100 | P2Wa | −80 |
| P2Cb | −100 | P2Wb | −80 |
| P3Ca | −20 | P3Wa | −10 |
| P3Cb | −20 | P3Wb | −10 |
| P4Ca | 0 | P4Wa | 0 |
| P4Cb | −10 | P4Wb | 0 |
| P5Ca | 0 | P5Wa | 0 |
| P5Cb | 0 | P5Wb | 0 |
| P6Ca | 0 | P6Wa | 5 |
| P6Cb | 0 | P6Wb | 0 |
| P7Ca | 0 | P7W | 0 |
| P7Cb | 10 | P8W | 5 |
| P8C | 0 | | |

TABLE 3

| | Power | | Power |
|---|---|---|---|
| Heating | Change | Heating | Change |
| Element | (W) | Element | (W) |
| P0C | 0 | | |
| P1Ca | 0 | P1Wa | −10 |
| P1Cb | −10 | P1Wb | −20 |
| P2Ca | −20 | P2Wa | −20 |
| P2Cb | −30 | P2Wb | −20 |
| P3Ca | −40 | P3Wa | 100 |
| P3Cb | 100 | P3Wb | 100 |
| P4Ca | 100 | P4Wa | 100 |
| P4Cb | 100 | P4Wb | 100 |
| P5Ca | 100 | P5Wa | −100 |
| P5Cb | −100 | P5Wb | −70 |
| P6Ca | −60 | P6Wa | −50 |
| P6Cb | −40 | P6Wb | −25 |
| P7Ca | −20 | P7W | 0 |
| P7Cb | 0 | P8W | 0 |
| P8C | 0 | | |

The values shown in Tables 2 and 3 represent a change in power settings relative to a positive uniform power setting for all of the heating elements 212. As shown in FIG. 16A and Table 2, increasing the power settings of heating elements 212 positioned near the inlet end 52 of the trough 61 produces a peak in temperature response near the inlet end 52. Particularly, the peak in temperature response shown in FIG. 16A (a maximum of about +4.5° C. for the surface portion at a normalized position of 0.15) resulted from: an increase in power of 100 watts applied to the heating elements 212 P1Ca, P1Cb, P1Wa, P1Wb; a decrease in power of 100 watts applied to the heating elements 212 P2Ca, P2Cb; and a decrease in power ranging from 80 watts to 10 watts applied to the heating elements 212 P2Wa, P2Wb, P3Ca, P3Cb, P3Wa, P3Wb, P4Cb.

As shown in FIG. 16B and Table 3, increasing the power settings of heating elements 212 positioned generally at the middle of the trough 61 combined with decreasing the power settings of adjacent heating elements 212 provides a peak in positive temperature response at the surface of the molten glass MG at the middle of the trough 61. Particularly, the peak in temperature response shown in FIG. 16B (a maximum of about +4.5° C. for the surface portion at a normalized position of 0.6 from the inlet end 52 and a maximum of about +3.2° C. for the center and lower portions at a normalized position of about 0.7 from the inlet end 52) resulted from: an increase in power of 100 watts applied to the heating elements 212 P3Cb, P3Wa, P3Wb, P4Ca, P4Cb, P4Wa, P4Wb, P5Ca; a decrease in power ranging from 40 watts to 10 watts applied to heating elements 212 P3Ca, P2Cb, P2Wb, P2Ca, P2Wa, P1Cb, P1Wb, P1Wa (heating elements positioned proximate to the inlet end 50 of the trough 61; and a decrease in power ranging from 100 watts to 20 watts applied to heating elements 212 P5Wa, P5Cb, P5Wb, P6Ca, P6Cb, P6Wa, P6Wb, P7Ca (heating elements positioned proximate to the distal end 58 of the trough 61). Accordingly, FIGS. 16A-16B and Tables 2-3 demonstrate that changing the power settings to the heating elements 212 along the length of the trough 61 provides temperature control of molten glass MG in the trough 61, which, in turn, can be used to adjust the mass flow characteristics of the glass along the length of the forming body.

### Example 5

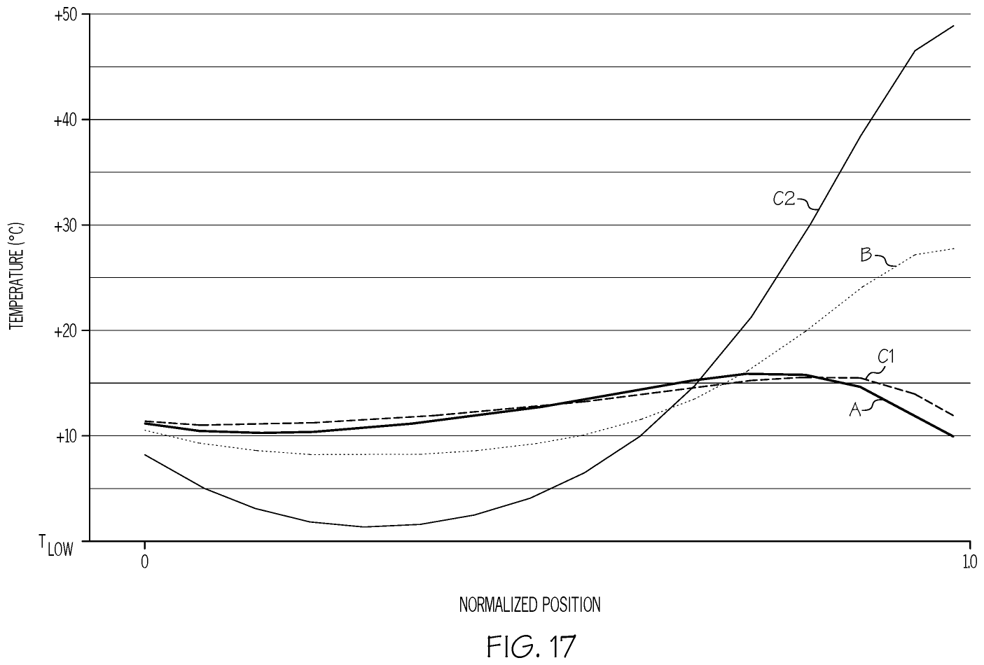

Referring to FIGS. 1, 2, 10A and 17, mathematical models were developed for a heating element 300 positioned above a trough 61 of a forming body 60. Particularly, FIG. 17 graphically depicts modeling results for four different thermal zone configurations for the heating elements 300A, 300B, 300C depicted in FIG. 10A with zone length, zone electrical resistance, zone power and zone power density shown in Table 4 (column A refers to heating element 300A, column B refers to heating element 300B, columns C1 and C2 refer to heating element 300C).

TABLE 4

| | Data Curve | | | |
|---|---|---|---|---|
| | A | B | C1 | C2 |
| Heating element | 300A - 1 zone | 300B - 2 zones | 300C - 3 zones | 300C - 3 zones |
| Zone length | ZA1: L | ZB1: 0.70 L | ZC1: 0.08 L | ZC1: 0.25 L |
| | | ZB2: 0.30 L | ZC2: 0.67 L | ZC2: 0.50 L |
| | | | ZC3: 0.25 L | ZC3: 0.25 L |
| Zone Electrical | ZA1: Ω1 | ZB1: Ω1 | ZC1: Ω3 | ZC1: Ω2 |
| Resistance | | ZB2: Ω2 | ZC2: Ω1 | ZC2: Ω1 |
| | | | ZC3: Ω2 | ZC3: Ω2 |
| Zone Power | ZA1: P | ZB1: 0.63P | ZC1: 0.00P | ZC1: 0.50P |
| | | ZB2: 0.37P | ZC2: 0.60P | ZC2: 0.54P |
| | | | ZC3: 0.40P | ZC3: 0.50P |
| Zone Power Density | ZA1: PD | ZB1: 0.84PD | ZC1: 0.00PD | ZC1: 1.89PD |
| | | ZB2: 1.50PD | ZC2: 0.89PD | ZC2: 1.05PD |
| | | | ZC3: 1.50PD | ZC3: 1.89PD |

The heating element 300A corresponding to curve ‘A’ in FIG. 17 has a single thermal zone ZA1 in the form of a “hot zone” with an electrical resistance of Ω1, a reference length ‘L’ and a reference power ‘P’ applied to the thermal zone ZA1. The power density through the thermal zone ZA1 is ‘PD’. The heating element 300B corresponding to curve ‘B’ in FIG. 17 has a first thermal zone ZB1 in the form of a “hot zone” with a first electrical resistance of Q1 and a length of about 0.7 L, and a second thermal zone ZB2 in the form of a “very hot zone” with a second electrical resistance of 522 and a length of about 0.3 L. The first thermal zone ZB1 (hot zone) has 0.63 P of power applied thereto and the second thermal zone ZB2 (very hot zone) has 0.37 P of power applied thereto. The power density through the first thermal zone ZB1 (hot zone) is about 0.84 PD and the power density through the second thermal zone ZB2 (very hot zone) is about 1.50 PD. The heating element 300C has a first thermal zone ZC1 with a first electrical resistance, a second thermal zone ZC2 with a second thermal resistance different than the first electrical resistance, and a third thermal zone ZC3 with a third electrical resistance different than the first electrical resistance, different than the second electrical resistance or different than both the first electrical resistance and the second electrical resistance. Particularly, the heating element 300C corresponding to curve labeled ‘C1’ in FIG. 17 has a first thermal zone ZC1 in the form of a “cold zone” with a first electrical resistance of S23 and a length of about 0.08 L, a second thermal zone ZC2 in the form of a “hot zone” with a second electrical resistance of Q1 and a length of about 0.67 L, and a third thermal zone ZC3 in the form of a “very hot zone” with a third electrical resistance of Q2 and a length of about 0.25 L. The first thermal zone ZC1 (cold zone) has no power applied thereto, the second thermal zone ZC2 (hot zone) has 0.60 P of power applied thereto and the third thermal zone ZC3 (very hot zone) has 0.40 P of power applied thereto. The power density through the first thermal zone ZC1 (hot zone) is about 0.0 PD, the thermal density through the second thermal zone ZC2 (hot zone) is about 0.89 PD, and the thermal density through the third thermal zone ZC3 (very hot zone) is about 1.50 PD.

The heating element 300C corresponding to the curve ‘C2’ in FIG. 17 has a first thermal zone ZC1 in the form of a “very hot zone” with a first electrical resistance of Ω2 and a length of about 0.25 L, a second thermal zone ZC2 in the form of a “hot zone” with a second electrical resistance of Ω1 and a length of about 0.5 L inches, and a third thermal zone ZC3 in the form of a “very hot zone” with the first electrical resistance of Ω2 and a length of about 0.25 L. The first thermal zone ZC1 and third thermal zone ZC3 (very hot zones) each have 0.50 P of power applied thereto and the second thermal zone ZC2 (hot zone) has 0.54 P of power applied thereto. The power density in the first thermal zone ZC1 and third thermal zone ZC3 (very hot zones) is about 1.89 PD and the thermal density in the second thermal zone ZC2 (hot zone) is about 1.05 PD.

Referring to 14, the heating element 300A corresponding to curve ‘A’ with a single thermal zone ZA1 (hot zone; curve A) results in the molten glass MG in the trough 61 having an average temperature of about 12° C. above a reference temperature ‘T_{LOW}’. The temperature of the molten glass MG is about 11° C. above T_{LOW} at the inlet end 52, increases in temperature to about 16° C. above T_{LOW} at a normalized position of about 0.7 from the inlet end 52, and then decreases in temperature to about 10° C. above T_{LOW} at a normalized position of about 1.0 from the inlet end 52. The heating element 300B corresponding to curve ‘B’ with two zones ZB1, ZB2 (hot zone, very hot zone) results in the molten glass MG in the trough 61 having an average temperature of about 11° C. above T_{LOW}. The temperature of the molten glass MG is about 10° C. above T_{LOW} at the inlet end 52, decreases in temperature to about 8° C. above T_{LOW} at a normalized position of about 0.2 from the inlet end 52, maintains the temperature of about 8° C. above T_{LOW} to a normalized position of about 0.4 from the inlet end 52, and then increases in temperature to about 28° C. above T_{LOW} at a normalized position of about 1.0 from the inlet end 52. The heating element 300C corresponding to curve ‘C1’ with three zones ZC1 (very hot zone), ZC2 (hot zone), ZC3 (very hot zone) results in the molten glass MG in the trough 61 having an average temperature of about 12° C. above T_{LOW}. The temperature of the molten glass MG is about 11° C. above T_{LOW} at the inlet end 52, increases in temperature to about 15° C. above T_{LOW} at a normalized position of about 0.8 from the inlet end 52, and then decreases in temperature to about 12° C. above T_{LOW} at a position of about 1.0 from the inlet end 52. The heating element 300C corresponding to curve ‘C2’ with three zones ZC1 (cold zone), ZC2 (hot zone), ZC3 (very hot zone) results in the molten glass MG in the trough 61 having an average temperature of about 9° C. above T_{LOW}. The temperature of the molten glass MG is about 8° C. above T_{LOW} at the inlet end 52, decreases in temperature to about 1° C. above T_{LOW} at a normalized position of about 0.3 from the inlet end 52, and then increases in temperature to about 49° C. above T_{LOW} at a position of about 1.0 from the inlet end 52. Accordingly, FIG. 17 illustrates the temperature of molten glass MG in the trough 61 can be controlled using heating elements with different thermal zones and, hence, heating elements with different thermal zones can be used to adjust the mass flow characteristics of the molten glass along the length of the forming body.

### Example 6

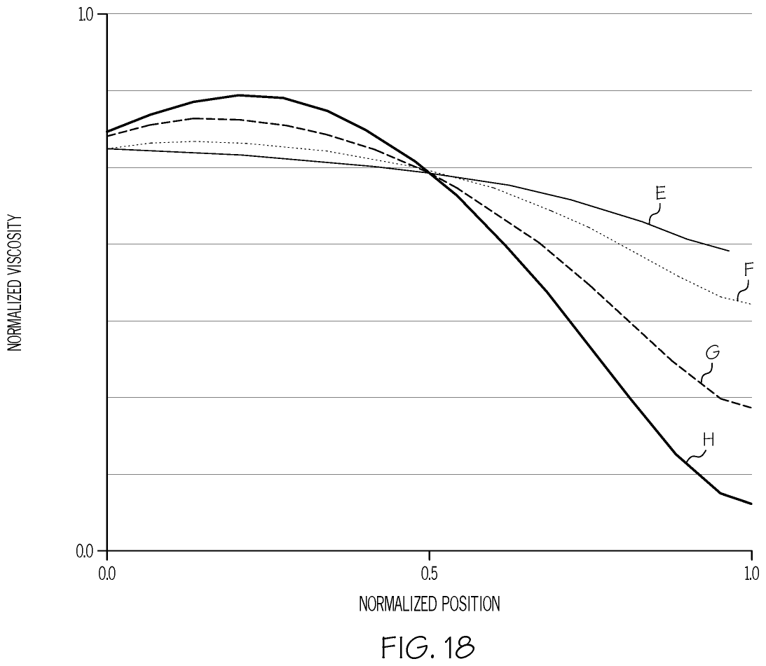

Referring to FIGS. 1, 2, 11 and 18, mathematical models were developed for a heating element 300 positioned above a trough 61 of a forming body 60 and a thermal element 314, in the form of a heating element, positioned within the inlet end 52 of the forming body 60. Particularly, FIG. 18 graphically depicts modeling results for normalized viscosity along the length of the trough 61 (labeled as “NORMALIZED POSITION”) for four different heating element 300 and thermal element 314 configurations. The heating element 300 for each of the thermal element 314 configurations has a total power of P applied thereto. The zones referred to below as “cold zones” have an electrical resistance of Ω3 and the zones referred to below as “hot zones” have an electrical resistance of Ω1. The data curve labeled ‘E’ corresponds to the heating element 300A depicted in FIG. 11 having a single thermal zone ZA1 (hot zone) extending along the length of the trough 61 and no thermal element 314 present in the inlet end 52. The normalized viscosity of the molten glass MG at the inlet end 52 is about 0.8 and gradually decreases to about 0.7 at a normalized position of about 1.0 from the inlet end 52. The data curve labeled ‘F’ corresponds to the heating element 300B depicted in FIG. 11 having two thermal zones ZB1, ZB2 and a thermal element 314 in the form of a heating element within the inlet end 52 of the forming body 60. Particularly, the heating element 300B has a first thermal zone ZB1 in the form of a “cold zone” extending to a normalized position of about 0.3 from the inlet end 52 and a second thermal zone ZB2 in the form of a “hot zone” extending from the normalized position of about 0.3 to the normalized position of 1.0 from the inlet end 52. The normalized viscosity of the molten glass MG at the inlet end 52 is about 0.8 and gradually decreases to about 0.6 at a normalized position of about 1.0 from the inlet end 52. The data curve labeled ‘G’ corresponds to the heating element 300B having two thermal zones ZB1, ZB2 and a thermal element 314 in the form of a heating element positioned within the inlet end 52 of the forming body 60. Particularly, the heating element 300B has a first thermal zone ZB1 in the form of a “cold zone” extending to a normalized position of about 0.2 from the inlet end 52 and a second thermal zone ZB2 extending from the normalized position of about 0.2 to the normalized position 1.0 from the first thermal zone ZB1. The normalized viscosity of the molten glass MG at the inlet end 52 is about 0.8, increases to about 0.83 at a normalized position of about 0.2 from the inlet end 52 and decreases to about 0.4 at the normalized position of about 1.0 from the inlet end 52. The data curve labeled ‘H’ corresponds to the heating element 300A having a single thermal zone ZA1 and a thermal element 314 positioned within the inlet end 52 of the forming body 60. Particularly, the heating element 300A has a thermal zone ZA1 in the form of a “hot zone” extending to a normalized position of about 1.0 from the inlet end 52. The normalized viscosity of the molten glass MG at the inlet end 52 is about 0.8, increases to about 0.9 at a normalized position of about 0.3 from the inlet end 52 and decreases to about 0.3 at the normalized position of about 1.0 from the inlet end 52. Accordingly, FIG. 18 illustrates the heating elements 300A, 300B, 300C with different thermal zones combined with the thermal element 314 positioned within the inlet end 52 of the forming body 60 may be used to provide additional control of the temperature and viscosity of molten glass MG in the trough 61 and, hence, the mass flow characteristics of the glass along the length of the forming body.

Although heating elements with thermal zone configurations of one thermal zone, two thermal zones and three thermal zones are disclosed and discussed herein, it should be appreciated that heating elements with more than three thermal zones may be used to provide additional control of the temperature and viscosity of molten glass MG in the trough 61. Also, the exact thermal zone configurations disclosed and discussed herein should not be considered limiting as other thermal zone configurations may be used to provide additional control of the temperature and viscosity of molten glass MG in the trough 61. For example, a heating element with two cold zones and one hot zone or two cold zones with one very hot zone may be used to provide additional control of the temperature and viscosity of molten glass MG in the trough 61.

Based on the foregoing, it should now be understood that the glass forming apparatuses and methods described herein can be used to compensate for dimensional changes of a forming body of a glass forming apparatus. The use of an array of thermal elements positioned above or along the sides of a trough or one or more heating elements positioned above a trough of a forming body with molten glass therein provide local heating and cooling of the molten glass which may be used to manipulate mass flow of the molten glass from the trough and down the side surfaces to the root. The use of a heating element within an inlet end of a forming body may also be used to manipulate mass flow of the molten glass from the trough and down the side surfaces to the root. The manipulation of the mass flow allows for manipulation of glass sheet thickness which may be used to compensate for the dimensional changes of the glass ribbon forming campaigns.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A glass forming apparatus, comprising:
an enclosure with a top panel and a pair of side panels;
a forming body positioned within the enclosure, the forming body comprising a trough for receiving molten glass positioned below the top panel of the enclosure, the trough defined by an inlet end, a distal end, a first weir and a second weir opposite and spaced apart from the first weir, and a base extending between the first weir and the second weir along a length of the forming body, wherein the first weir and the second weir extend from the inlet end to the distal end at an incline with respect to horizontal, and the top panel of the enclosure is positioned above and extends substantially parallel to and across top surfaces of the first weir and the second weir along the length of the forming body;
a support plate positioned above and extending substantially parallel to and across the top panel of the enclosure along the length of the forming body; and
a plurality of thermal elements suspended from the support plate along the length of the forming body;
wherein the plurality of thermal elements locally heat or cool molten glass within the trough.

2. The glass forming apparatus of claim 1, wherein the plurality of thermal elements are of uniform length.

3. The glass forming apparatus of claim 2, wherein the plurality of thermal elements comprise a plurality of heating elements, the plurality of heating elements each comprising a bottom portion, wherein the bottom portions are positioned generally equidistant from the top panel of the enclosure along the length of the forming body.

4. The glass forming apparatus of claim 1, wherein the plurality of thermal elements comprise a plurality of heating elements of uniform length and at least one cooling element.

5. The glass forming apparatus of claim 1, further comprising a plurality of thermal shields suspended from and extending along a length and a width of the support plate, wherein the plurality of thermal shields form a plurality of hollow columns and the plurality of thermal elements are positioned within the plurality of hollow columns.

6. The glass forming apparatus of claim 5, wherein the plurality of hollow columns are of uniform cross-sectional size and volume.

7. The glass forming apparatus of claim 1, wherein the support plate comprises a plurality of openings and the plurality of thermal elements extend through the plurality of openings.

8. The glass forming apparatus of claim 1, wherein the first weir and the second weir extend from the inlet end to the distal end at a negative incline with respect to horizontal.

9. The glass forming apparatus of claim 1, wherein the support plate comprises a first portion extending substantially parallel to and across an inlet end of the forming body and a second portion non-linear with the first portion extending substantially parallel to and across the top panel of the enclosure along the length of the forming body.

10. The glass forming apparatus of claim 1, further comprising at least one side thermal element extending along at least one of the pair of side panels of the enclosure.

11. A method for forming a glass ribbon, comprising:
directing molten glass into a trough of a forming body, the trough defined by an inlet end, a distal end, a first weir and a second weir opposite and spaced apart from the first weir, and a base extending between the first weir and the second weir along a length of the forming body, the forming body enclosed within an enclosure with a top panel, wherein the first weir and the second weir extend from the inlet end to the distal end with an incline relative to horizontal, and the top panel is positioned above and extends substantially parallel to and across top surfaces of the first weir and the second weir along the length of the forming body;
flowing the molten glass over the first weir and the second weir and down along a first forming surface and a second forming surface extending from the first weir and the second weir, respectively, the first forming surface and the second forming surface converging at a root and the molten glass flowing down along the first forming surface and the second forming surface converging at the root and forming the glass ribbon;
locally heating or cooling the molten glass in the trough with a plurality of thermal elements positioned above the forming body and suspended from a support plate, the support plate positioned above and extending substantially parallel to the top panel of the enclosure along the length of the forming body;
wherein the locally heating or cooling the molten glass in the trough manipulates temperature and viscosity of the molten glass along the length of the trough.

12. The method of claim 11, wherein the plurality of thermal elements are of uniform length.

13. The method of claim 12, wherein the plurality of thermal elements comprise a plurality of heating elements, each of the plurality of heating elements comprising a bottom portion that is equidistant from the top panel of the enclosure along the length of the forming body.

14. The method of claim 13, further comprising replacing one of the plurality of heating elements with a cooling element.

15. The method of claim 11, further comprising a plurality of thermal shields suspended from and extending along a length and a width of the support plate, wherein the plurality of thermal shields form a plurality of hollow columns and the plurality of thermal elements are positioned within the plurality of hollow columns.

16. The method of claim 15, wherein the plurality of hollow columns comprise the same cross-sectional size and volume.

17. The method of claim 11, wherein the support plate comprises a plurality of openings and the plurality of thermal elements extend through the plurality of openings.

18. The method of claim 11, wherein the first weir and the second weir extend from the inlet end to the distal end at a negative incline with respect to horizontal.

19. The method of claim 11, wherein the support plate comprises a first portion extending substantially parallel to and across an inlet end of the forming body and a second portion non-linear with the first portion extending substantially parallel to and across the top panel of the enclosure along the length of the forming body.

20. The method of claim 11, wherein the locally heating or cooling the molten glass in the trough with the plurality of thermal elements positioned above the forming body and suspended from the support plate comprises independently controlling electrical power or cooling fluid to each of the plurality of thermal elements.
